(19) United States
(12) Patent Application Publication
(10) Pub. No.: US 2023/0327189 A1
(43) Pub. Date: Oct. 12, 2023

(54) MOLTEN FLUID APPARATUS WITH SOLID ELECTROLYTE COMPRISING A MIXTURE OF A PLURALITY OF SALTS

(71) Applicant: Vissers Battery Corporation, Wheaton, IL (US)

(72) Inventor: Daniel R. Vissers, Wheaton, IL (US)

(21) Appl. No.: 18/128,736

(22) Filed: Mar. 30, 2023

Related U.S. Application Data
(60) Provisional application No. 63/328,432, filed on Apr. 7, 2022.

(51) Int. Cl. H01M 10/0562; H01M 10/39

(52) U.S. Cl. CPC H01M 10/0562; H01M 10/39; H01M 2300/008

(57) ABSTRACT

A battery includes a fluid negative electrode and a fluid positive electrode separated by a solid electrolyte at least when the electrodes and electrolyte are at an operating temperature. The solid electrolyte comprises a mixture of a plurality of salts with at least one of the salts having cations of the negative electrode material. Each of the plurality of salts has a proportion in the mixture where the proportions determine an absolute melting point of the mixture such that the solid electrolyte is in a solid state at least within the operating temperature range of the apparatus. In one example, the fluid negative electrode comprises lithium (Li), the fluid positive electrode comprises sulfur (S) and at least one of the salts comprises lithium cations.

### CLAIM OF PRIORITY

The present application claims priority to Provisional Application No. 63/328,432 entitled “MOLTEN FLUID APPARATUS WITH SOLID ELECTROLYTE COMPRISING A MIXTURE OF A PLURALITY OF SALT”, docket number VCB008P, filed Apr. 7, 2022, which is assigned to the assignee hereof and hereby expressly incorporated by reference in its entirety.

### FIELD

This invention generally relates to thermal batteries and more particularly to methods, devices, and systems with molten fluid electrodes with a solid electrolyte comprising a mixture of a plurality of salts.

### BACKGROUND

A battery generally includes a positive electrode (cathode), a negative electrode (anode) and an electrolyte. A battery typically includes current collectors within the electrodes that direct electrical current to the terminals of the battery. Attempts have been made to use fluids for electrodes where one or both of the electrodes are maintained in a fluid state by heating the electrode material. These batteries are sometimes referred to as thermal batteries or high temperature batteries and include, for example, devices sometimes referred to as liquid-metal batteries and rechargeable liquid-metal batteries.

### BRIEF DESCRIPTION OF THE DRAWINGS

It is to be understood that the drawings are solely for purpose of illustration and do not define the limits of the appended claims. Furthermore, the components in the figures are not necessarily to scale. In the figures, like reference numerals designate corresponding parts throughout the different views.

FIG. 1 is a block diagram of an example of a battery apparatus including a reaction chamber having fluid electrodes separated by a eutectic salt mixture solid electrolyte (salt mixture solid electrolyte) that comprises a mixture of a plurality of salts.

FIG. 2 is an illustration of an example of a relationship of an apparatus operating temperature range to a phase diagram for two salts that form a eutectic salt system where the solid electrolyte of the apparatus comprises the two salts.

FIG. 3 is a block diagram of an example of a battery including a fluid lithium (Li) negative electrode and a fluid sulfur (S) positive electrode separated by a solid electrolyte with a salt mixture having at least one lithium salt.

FIG. 4 is an illustration of an example of a portion of a lithium salt mixture solid electrolyte material with lattice defects. Accordingly, the material is an example of a material that comprises a mixture of salts as discussed above where defects are introduced into the salt lattice.

FIG. 5 is an illustration of a portion of the lithium salt mixture solid electrolyte for an example where the plurality of defects is a plurality of grain boundary defects that may be due to dangling bonds, changes in bonding, vacancies, and other defects occurring at the grain boundary.

FIG. 6 is an illustration of a portion of the lithium salt mixture solid electrolyte with defects for an example where the nanoparticle material is magnesium oxide (MgO).

FIG. 7 is an illustration of an example of a portion of the solid lithium salt electrolyte material including aliovalent substitution that induces an aliovalent substitution defect.

FIG. 8 is an illustration of an example of a block of open cell metal foam suitable for use with the solid electrolyte within a thermal battery.

FIG. 9A is an illustration of an example of a cross section of the metal foam.

FIG. 9B is an illustration of an example of a cross section of the metal foam 600 after a dielectric material has been deposited to the metal foam structure.

FIG. 9C is an illustration of an example of a cross section of the dielectric coated metal foam after the lithium salt mixture has been flowed, poured or otherwise deposited into the metal foam.

FIG. 10 is an illustration of an example of a thermal battery with a lithium salt mixture solid electrolyte with defects that includes protective layers between the electrolyte and the electrodes.

FIG. 11 is a flowchart of an example of a method of designing a salt mixture solid electrolyte for a high-temperature fluid electrode battery.

FIG. 12 is a block diagram of a cross-sectional view of an example of a battery apparatus including a reaction chamber having fluid electrodes separated by a reinforced solid electrolyte including a solid electrolyte with a reinforcing structure positioned between the solid electrolyte and each of the electrodes.

FIG. 13 is a block diagram of a cross-sectional view of an example of a battery with electrolyte reinforcing current collectors where components of the reinforcing structure form current collectors.

FIG. 14 is a block diagram of a cross-sectional view of an example of a battery with a reinforcing structure including a negative region component, a positive region component, and a third component.

FIG. 15 is a block diagram of a cross-sectional view of an example of a battery where the third component is a sealing component.

FIG. 16 is an illustration of an example of a block of open cell foam suitable for use as a reinforcing structure component to reinforce the solid electrolyte within a thermal battery.

FIG. 17 is an illustration of an example of a section of wire mesh structure suitable for use as a reinforcing structure component to reinforce the solid electrolyte within a thermal battery.

### DETAILED DESCRIPTION

Thermal batteries have several advantages over other types of batteries. The relatively low cost, high energy density, and high power density of thermal batteries (high temperature batteries) make these types of batteries highly attractive for several uses. Unfortunately, the safety issues with these devices have constrained widespread adoption. Due to highly energetic chemistry, thermal batteries have suffered from dangerous risks of fire and explosion. Conventional thermal battery designs include two pools of fluid (i.e., molten) materials separated by a third material. If the third material fails and allows the molten materials to mix and react, an immense amount of thermal energy is released in a short period of time. These conditions often lead to a dangerous fire condition or explosion.

Thermal batteries provide several advantages over other batteries including exhibiting a high gravimetric energy density (kWh/kg), high volumetric energy density, high gravimetric power density, and high volumetric power density at low cost. Conventional thermal batteries with fluid electrodes, however, suffer from a significant safety limitation. The electrolyte separators used in conventional thermal batteries include liquid electrolytes such as molten salts and brittle solid electrolytes such as ceramic and glass. Liquid electrolytes are limited in several ways. For example, during operation of these types of batteries, chemical species of the electrode materials are produced and permeate the electrolyte decreasing performance. Eventually, these byproducts in the electrolyte result in the battery ceasing to operate. Ceramic and glass electrolytes, on the other hand, can easily fail because of their brittle structure. As discussed above, significant fire conditions and explosions occur when the molten electrode materials come in contact with each other after the solid electrolyte separator is breached.

Solid electrolytes comprising glass or a ceramic have been proposed as solid electrolytes for use in a thermal battery with fluid electrodes. These materials have significantly higher melting points than the melting points of the electrodes. As a result, one or both of the electrode materials may enter the gas phase at temperatures approach the melting point of the glass or ceramic electrolyte. As a result, the glass and ceramic electrolytes cannot be operated at a temperature where the electrolyte is less brittle and more flexible.

In accordance with the techniques discussed herein, the safety of a thermal battery is maximized by using a solid yet relatively non-brittle electrolyte to separate the fluid electrodes. Within the operating temperature range of the battery, the electrolyte material has a solid yet relatively soft, less brittle structure compared to ceramic and glass, making the electrolyte significantly less susceptible to cracking and fractures than conventional thermal batteries. The solid electrolyte is formed with a eutectic salt system mixture including at least two salts where at least one of the salts includes cations of the negative electrode material. Since each salt includes a cation and an anion, the solid electrolyte also includes anions.” A eutectic salt mixture at the eutectic composition is a homogeneous mixture of salts that melts and solidifies at a single temperature that is lower than the melting points of each salt separately or of any other composition (proportions of salts) of the mixture. In other words, a mixture of the salts with different proportions of the salts than the proportions of the eutectic composition will have a higher melting point that the eutectic melting point. The melting point of the mixture, therefore, depends on the amount of each salt relative to the other salt(s) and increases relative to the eutectic melting point temperature as the ratio of salts deviates from the eutectic composition (proportions of salts resulting in the lowest melting point). The melting point of the electrolyte, therefore, can be manipulated by selecting the proportion of each salt that results in a mixture having the desired melting point. Where the salt system includes two salts, two different mixtures of the two salts may result in the same melting point. A mixture with more than two salts may have multiple mixtures having different proportions of the salts that result in the same melting point that is higher than the eutectic melting point. The selection of the particular ratio, therefore, may be further based on other factors such as cost and performance. As mentioned above, the solid electrolyte also comprises anions. For the examples herein, the anion is selected to be relatively large and chemically stable with the materials within the reaction chamber. Therefore, in the examples, the anion is stable with the negative electrode material, the positive electrode material, and any resulting species of the materials. A relatively larger anion generally increases the ion transport through the solid electrolyte since a larger anion tends to have less of a hold on the cation than smaller anions.

For some specific examples discussed below, the negative electrode comprises lithium, the positive electrode comprises sulfur, and the solid electrolyte comprises at least one salt comprising lithium cations (Li⁺). The solid electrolyte may include other elements and additives in some circumstances. Even where the additives may have a brittle structure, the overall structure of the solid electrolyte in accordance with the techniques discussed herein is less brittle and less susceptible to cracking than ceramic electrolytes and glass electrolytes. By operating the battery at a temperature that is near but below the melting point of the salt system, the electrolyte may become soft and may be less susceptible to cracking and fracture. Applying such a technique with electrolyte materials that have significantly higher melting points, greatly increases the complexity and cost of the battery since such implementations need to consider the electrode materials in the gas phase and the increase in material corrosion at these elevated temperatures. Therefore, the example of the lithium sulfur thermal battery with a solid electrolyte comprising a eutectic salt system including lithium ions provides a safer, low-cost thermal battery with high energy densities for use in a variety of applications including electric vehicles.

For the examples discussed below, the positive electrode and the negative electrode are in a fluid state when the battery is at a temperature within an operating temperature range of the battery. In some implementations, however, one of the electrodes may be in a solid state when the battery temperature is within the operating temperature range. In other words, only the positive electrode or the negative electrode is in a fluid state while the other is solid within the operating temperature range. In addition, in some circumstances, the operating temperature range may include temperatures where both electrodes are fluid and temperatures where only one electrode is fluid. When a material is in the fluid state, it is fluid, and when a material is in the non-fluid state, it is non-fluid. For the examples discussed herein, the electrode materials are transitioned from a non-fluid state to a fluid state by heating and can be referred to as molten electrode materials and molten fluid electrode materials.

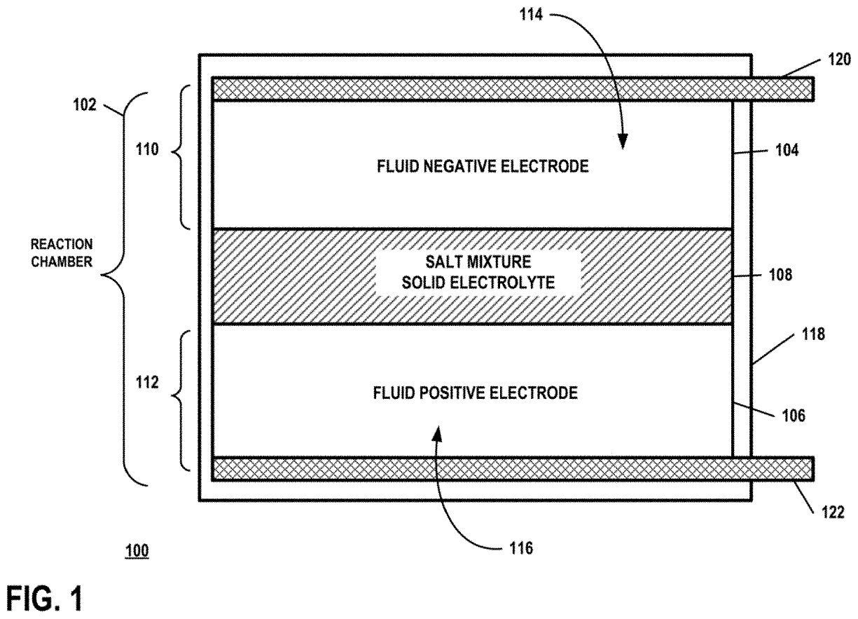

FIG. 1 is a block diagram of an example of a battery apparatus 100 including a reaction chamber 102 having fluid electrodes 104, 106 separated by a eutectic salt mixture solid electrolyte (salt mixture solid electrolyte) 108 that comprises a mixture of a plurality of salts. The illustration in FIG. 1 depicts the general principles of the example and does not necessarily represent specific shapes, relative sizes, distances, or other structural details of the represented components. In some circumstances, the structures of two or more blocks may be implemented in a single component or structure. In addition, functions described as performed in a single block of FIG. 1 may be implemented in separate structures.

As discussed herein, a material is in a fluid state when the material has a consistency sufficiently liquefied to allow the material to flow from one area to another. In other words, the viscosity of a fluid material is such that the material can be directed, pumped, or can otherwise flow from one area to another. A fluid material may, however, have some components that are at least partially solid while others are in a liquid phase. As a result, a fluid material is not necessarily all in a liquid phase. As discussed herein, a material is in a non-fluid state where it is sufficiently solidified such that it cannot flow. In other words, the viscosity of the material in a non-fluid state is such that the material cannot be directed, pumped, or otherwise allowed to flow from one area to another. A non-fluid material, however, may have some components that are in a liquid phase as well as others that are in a solid phase. As referred to herein, a eutectic salt mixture solid electrolyte is a mixture of at least two salts that forms an electrolyte structure that is in a solid phase where the at least two salts can form a eutectic mixture. The mixture, therefore, is comprised of salts that form a eutectic system where a eutectic composition (portions of the salts) results in a mixture that melts and solidifies at a single temperature (eutectic melting point) that is lower than the melting point of the individual salts and any other mixture of the salts with a different composition (proportions of the salts). As discussed below in further detail, the proportions of salts can be adjusted when designing the solid electrolyte 108 in order to establish a desired melting point of the solid electrolyte 108 that can be higher than the eutectic melting point temperature. Although the eutectic salt mixture is homogeneous, the solid electrolyte may include other materials or particles in addition to the eutectic salt mixture. As a result, the solid electrolyte may not be homogenous although the salt mixture is homogenous.

Although the solid electrolyte is in the solid phase within the operating temperature range of the apparatus, the electrolyte material may soften as the temperature approaches its melting point. Therefore, when the solid electrolyte 108 is operated near its melting point and subjected to stress, it can absorb at least some energy prior to fracture and exhibits more plastic deformation than glass and ceramics. In other words, the solid electrolyte 108 is softer and exhibits a higher creep rate than glass and ceramics at the operating temperature of the battery.

The battery 100 includes at least a reaction chamber 102 having a negative electrode region 110 and a positive electrode region 112 separated from the negative electrode region 110 by the solid electrolyte 108. The negative electrode region 110 contains a negative electrode material 114 and the positive electrode region 112 contains a positive electrode material 116. The battery 100 also includes a heating system 118 for sufficiently heating the positive and negative electrode materials in the reaction chamber 102 during operation. The electrode materials 114, 116 are maintained in a fluid state when the battery 100 is operating by heating the electrode materials 114, 116 while maintaining the solid electrolyte 108 in a solid state. Accordingly, the operating temperature of the reaction chamber is below the melting point of the solid electrolyte 108. For the example of FIG. 1, the heating system 118 is an electrical heating system including one or more heating elements that facilitate the heating of the reaction chamber 102 to place and maintain the electrode materials 114, 116 in a fluid state. Other types of heating systems 118 can be used in some circumstances. The heating system heats the reaction chamber such that the negative electrode material 114 and the positive electrode material 116 are in a fluid state while the solid electrolyte 108 is maintained in a solid state.

The mixture salts of the solid electrolyte 108 include at least cations of the negative electrode material 114 and anions where the anion is selected to be relatively large and chemically stable with the materials within the reaction chamber 102. Some examples of negative electrode materials 114 include lithium, sodium, potassium, rubidium, and cesium. Some examples of anions include anions of chorine, bromine, fluorine, and iodine. Other materials can be used in some circumstances. All of the materials should be chemically stable with the materials within the reaction chamber.

The fluid negative electrode material 114 in the negative electrode region 110 forms a fluid negative electrode 104 of the battery 100. The fluid positive electrode material 116 in the positive electrode region 112 forms a fluid positive electrode 106 of the battery 100. The fluid electrodes 104, 106 and the electrode materials may include more than a single element. For example, the positive electrode region 112 may also contain some reaction products resulting from the reaction within the battery 100. A first current collector 120 is positioned within the fluid negative electrode 104 and second current collector 122 is positioned within the positive fluid electrode 106. With the properly placed current collectors 120, 122 within each electrode 104, 106, electrical energy can be harnessed from the electrochemical reaction occurring within the battery between the fluid negative electrode 104 and the fluid positive electrode 106 through the solid electrolyte 108. Therefore, the operation of the reaction chamber 102 in the example of FIG. 1 is similar to the operation of conventional thermal batteries. A significant advantage over conventional thermal batteries, however, includes the eutectic salt mixture solid electrolyte that is much more resistant to cracking and breaking compared to conventional solid electrolytes used in thermal batteries.

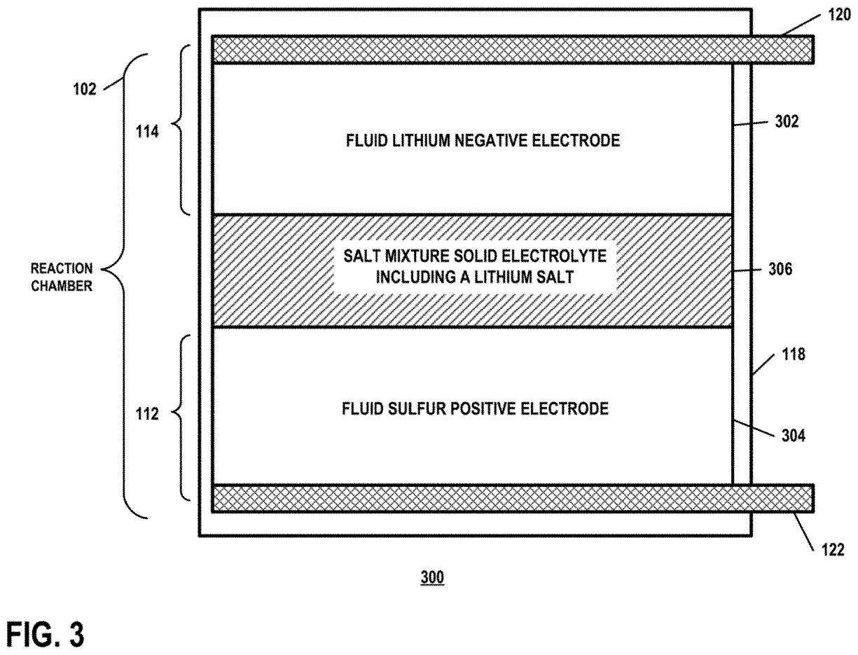

The battery apparatus 100 may be implemented with different materials and electrochemical couples. For the example discussed below with reference to FIG. 3, the negative electrode comprises lithium (Li) and the positive electrode comprises sulfur (S). In another example, a sodium-sulfur (NaS) battery includes a fluid negative electrode comprising sodium (Na) and a fluid positive electrode comprising sulfur (S). In addition, other materials may also be used for the electrodes. Further, the electrode materials may contain mixtures or compounds that include multiple elements in some circumstances. For example, in some liquid metal batteries, a molten mixture of sulfur and phosphorus can be used for the fluid positive electrode. In addition, defects may be introduced into the solid electrolyte lattice further improving performance. Also, reinforcing structures may be disposed within and/or adjacent to the solid electrolyte.

The operating temperature, or temperature ranges, of the negative electrode region and positive electrode region may be selected based on several factors including, for example, the melting point of the negative electrode material, the melting point of the positive electrode material, the boiling point of the negative electrode material, the boiling point of the positive electrode material, the eutectic point of the positive electrode material and resulting chemical species, and the eutectic melting point of the solid electrolyte. The techniques discussed herein allow for establishing a desired melting point of the solid electrolyte by adjusting the proportions of salts (mixture composition) of the eutectic salt mixture. For the examples discussed herein, the heating system 118 maintains the negative electrode region 110 and the positive electrode region 112 of the reaction chamber 102 at the same temperature in order to avoid a temperature gradient across the solid electrolyte 108. In some situations, however, the two regions of the reaction chamber may be maintained at different temperatures.

One of the advantages of the examples discussed herein includes having an electrolyte material with a softness at the battery operating temperature that minimizes cracking and fracture. As is known, a material generally becomes softer and exhibits increased flexibility and creep rate under stress at temperatures approaching their melting point. By including an electrolyte that has a melting point that is not significantly above the operating temperature range of the battery, the electrolyte is maintained in a solid form while exhibiting good sealing properties and increased softness. Accordingly, the electrolyte performs well as a separator that separates and seals the two fluid electrodes from each other while minimizing the chances of a failure as a result of mechanical vibrations or forces. This results in a significant advantage over conventional electrolyte materials used in thermal batteries with fluid electrodes. Glass electrolytes have melting points near 1,700° C. and BASE ceramics have melting points near 2,000° C. These melting points are significantly higher than the boiling points of electrode materials that exhibit high power and energy densities in thermal batteries. As mentioned above, for example, lithium sulfur thermal batteries have high energy and power densities. The boiling point of sulfur is 444.6° C., significantly lower than the melting points of glass and BASE ceramics. Operating a lithium sulfur battery at temperatures near the melting point of conventional electrolytes would place the sulfur in the gas phase complicating the design. As discussed in the example below, however, the advantages of a thermal lithium sulfur battery can be realized while minimizing dangers of electrolyte failure by using an electrolyte material with a lower melting point, greater softness, and better sealing properties than conventional thermal battery electrolyte materials.

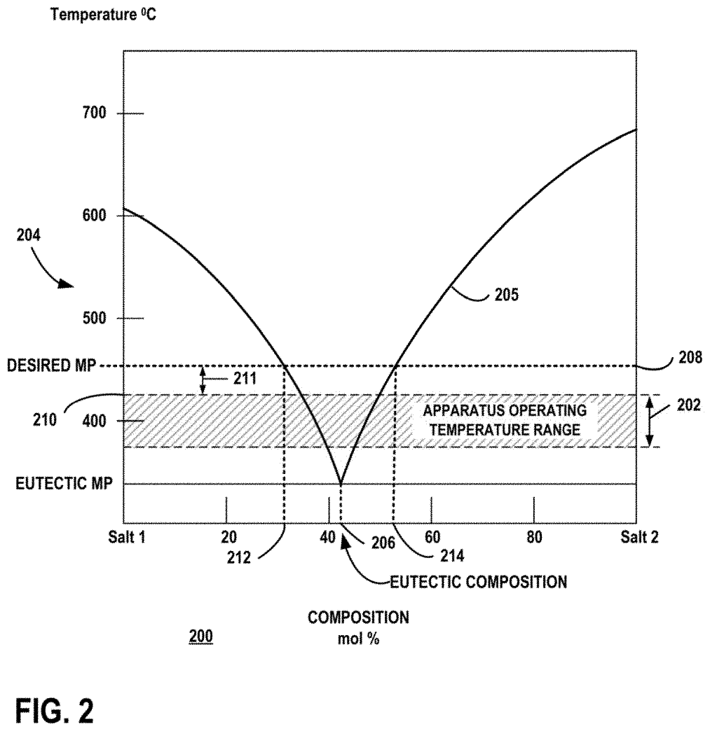

FIG. 2 is an illustration of an example of a relationship 200 of an apparatus operating temperature range 202 to a phase diagram 204 for two salts that form a eutectic salt system where the solid electrolyte of the apparatus comprises the two salts. The example of FIG. 2 is intended to convey the general relationships between the parameters in accordance with the general principles of selecting proportions of salts for a solid electrolyte. The example of FIG. 2, therefore, does not necessarily represent particular salts of a eutectic salt system.

The phase diagram 204 in FIG. 2 shows a relationship between different proportions of salts and the melting point of the salt mixture. The horizontal axis indicates the proportions of the two salts as a mole percentage (mol %) such that, left to right, the mole percentage of the first salt is decreases from 100 to 0 and the percentage of the second salt increases 0 to 100. The vertical axis is temperature in degrees Celsius (° C.). The melting point of the mixture is represented by the melting point plot line 205 which generally forms a “V” shape in the example. The eutectic melting point (eutectic point) 206 is the lowest melting point of the mixture which results with particular proportions of the two salts. This proportion of salts is typically referred to as the eutectic composition and is often expressed as a mole percentage or weight percentage. As shown in FIG. 2, the melting point of the mixture increases as the proportion of one salt decreases and the proportion of the other salt increases resulting in two different proportion combinations for each melting point other than the eutectic melting point.

A desired melting point 208 of the salt mixture can be established by adjusting the proportions of the salts (mixture composition). In one example, the desired melting point 208 is selected to be as close as possible to the highest temperature 210 of the apparatus operating temperature range 202 with minimal risk that the temperature of the apparatus will reach the desired melting point 208 at any time during operation. Accordingly, the desired melting point 208 may be selected such that a buffer 211 is established between the maximum operating temperature 210 and the melting point of the mixture to reduce the possibility that the mixture will melt during some unexpected, but possible, event. For example, a buffer 211 may be established in order to avoid consequences of an increased apparatus temperature resulting from an unexpected excessive electrical current flow through the apparatus.

The composition (proportion of salts) of the mixture can be adjusted to establish the melting point of the mixture to be at or near the desired melting point 208. For the example, the phase diagram 204 reveals that the desired melting point is achieved with a first composition 212 and second composition 214. Therefore, the desired melting point 208 may be established using either one of the two possible compositions 212, 214. In one example, the selection of the composition between the two compositions 212, 214 is at least partially based on the cost of the individual salts such that the composition using less of the more expensive salt is selected. Selection of the composition may be based on other factors and combination of factors. For example, the selection may be based on the ion transport characteristics of the two compositions.

When selecting the desired melting point 208 for a battery or other apparatus in accordance with the examples discussed herein, therefore, factors that may be considered include the absolute boiling points of the electrodes, the upper temperature 210 of the operating range 202 of the apparatus/battery and the buffer 211. Selecting a desired melting point near the upper temperature 210 of the operating range may provide at least two advantages. The solid electrolyte becomes more flexible and less brittle as the melting point of the salt mixture is decreased. Also, the ion transport through the solid electrolyte typically increases as the melting point of the salt mixture is decreased. The melting point of the salt mixture should not be so close to the upper temperature of the operating temperature range that it is possible that the temperature of the apparatus can exceed the upper temperature of the operating range and reach the melting point. In the examples, therefore, the desired melting point is selected to establish the minimum buffer that will maintain the integrity of the solid electrolyte during possible events where the battery temperature exceeds the upper temperature of the operating range. Examples of suitable absolute melting points of the salt mixture relative to the upper temperature of the operating temperature range of the battery include melting points where the upper temperature range is greater than 70 percent of the absolute melting point, greater than 75 percent of the absolute melting point, greater than 85 percent of the absolute melting point, greater than 90 percent of the absolute melting point, greater than 95 percent of the absolute melting point, greater than 98 percent of the absolute melting point, and greater than 99 percent of the absolute melting point.

As discussed herein, the eutectic salt system may include more than two salts in some circumstances resulting in more than two possible compositions for desired melting point. With a eutectic salt system including three salts, for example, the phase diagram includes a ternary eutectic and three binary eutectics where the desired melting point may intersect the three-dimensional phase plot in numerous locations. Accordingly, the principles discussed with reference to FIG. 2 may be expanded to eutectic salt systems having three, four, or more salts in the mixture.

FIG. 3 is a block diagram of an example of a battery 300 including a fluid lithium (Li) negative electrode 302 and a fluid sulfur (S) positive electrode 304 separated by a solid electrolyte 306 with a salt mixture having at least one lithium salt. Accordingly, the battery 300 can be referred to as a lithium-sulfur (LiS) battery and is an example of the apparatus 100 where the fluid negative electrode 302 comprises lithium, the fluid positive electrode 304 comprises sulfur and the solid electrolyte 306 comprises a eutectic salt system mixture with at least one lithium salt. The illustration in FIG. 3 depicts the general principles of the example and does not necessarily represent specific shapes, relative sizes, distances, or other structural details of the represented components. In some circumstances, the structures of two or more blocks may be implemented in a single component or structure. In addition, functions described as performed in a single block of FIG. 3 may be implemented in separate structures.

In addition to considerations such as eutectic melting point, softness, and cost, the selection of the particular eutectic salt mixture for the LiS thermal battery includes evaluating ionic transfer properties and the chemical stability of the material with lithium, sulfur and the Li₂Sₘ species. The operation of the LiS battery 300 is in accordance with the operation described with reference to the apparatus 100 of FIG. 1. The heating system 118 maintains the reaction chamber 102 at the appropriate temperature to facilitate the desired reaction between the sulfur and lithium through the solid electrolyte 306. For the example of FIG. 3, the temperature of the negative electrode region 114 and the positive electrode region 112 is maintained at a temperature around 400 degrees Celsius (° C.). As discussed above, the operating temperature may be based on several factors including the characteristics of the materials of the electrodes. For the example of FIG. 3, some of the characteristics that can be considered include the boiling point of sulfur, 444.6° C., and the eutectic melting point of lithium polysulfide products (LiₙSₘ), 365° C. Maintaining the temperature below the boiling point of sulfur may be useful and provide a range of 365° C. to 444° C. that can be used in some circumstances. A suitable temperature range, however, includes temperatures between 375° C. and 430° C. A narrower temperature range within the range of 390° C. to 425° C. may be used. The wider temperature range of 115.21° C. to 469° C. can also be used in still other situations. For the examples herein, the temperatures of the negative electrode region 114 and the positive electrode region 112 are maintained at approximately the same temperature. Among other advantages, such a scheme avoids a temperature gradient across the solid electrolyte 306. In some situations, however, the temperatures may be different between the electrode regions. Other temperature ranges and schemes can be used as long as the electrode materials are fluid and the electrolyte is solid. As a result, the temperature of the positive electrode region 112 should be above the melting point of sulfur, 115.21° C., and the negative electrode region 114 should be above the melting point of lithium, 180.5° C.

During operation of the battery 300, the reaction may result in other compounds or products being formed. For example, in addition to the positive electrode region containing sulfur, the region may also contain di-lithium polysulfide species (Li₂Sₙ where n is two or higher) and di-lithium sulfide (Li₂S). Typically, the reaction through the electrolyte will result is several different chemical species such as Li₂Sₘ where m is an integer equal to one or more. Any number of chemical species may result and may include, for example Li₂S, Li₂S₂, Li₂S₄, and Li₂S₆ products as well as others in some circumstances.

The solid electrolyte 306 comprises a mixture comprising at least two salts where at least one of the salts comprises lithium and is therefore referred to as a lithium salt. For the example, the composition of a eutectic system salt mixture including at least one lithium salt is adjusted to set the melting point of the mixture at a desired melting point. As discussed above, the desired melting point may be close to the upper limit (upper temperature) of the operating temperature range of the apparatus. Generally, as discussed above, the desired melting point may be set to be higher than the upper limit of the operating temperature range for the battery. In some situations, the desired melting point is set to be slightly above the upper limit of the operating temperature range for the battery 300 in order to accommodate an unexpected temperature increase above the upper limit. The selection of the desired melting point may be based on other battery features and components related to battery operation. The desired melting point, for example, may be partially based on the battery feature that stabilize or limit temperature increases. Such features may include a cooling mechanism or a temperature management system that reduces the chemical reaction or limits the battery operation to a maximum current. With more robust temperature controlling features, the desired melting point may be set to be closer to the maximum operating temperature with less risk of the solid electrolyte entering a liquid phase. For an example where the operating range of the battery 300 is between 375° C. and 425° C., a desired melting point of the salt mixture may be set at a temperature above 425° C. where an example of a suitable temperature includes any temperature between 426° C. and 600° C. Examples of other desired melting point temperatures include a temperature in a range between 430° C. and 490° C., a temperature in a range between 440° C. and 480° C., a temperature in a range between 445° C. and 475° C., and a temperature in a range between 450° C. and 470° C. In one example, the upper temperature of the operating temperature range of the apparatus is greater than 95 percent of the absolute melting point of the solid electrolyte and below 99 percent of the lowest absolute boiling point of a positive electrode absolute boiling point of the positive fluid electrode and a negative electrode absolute boiling point of the fluid negative electrode.

In some situations, additional materials may be added to the positive electrode material and/or to the negative electrode material. For example, phosphorus can be included in the positive electrode material resulting in a fluid phosphorus-sulfur positive electrode. Therefore, another example of the fluid electrode battery apparatus 100 is a lithium phosphorus-sulfur (LiPS) battery. In one example, therefore, the positive electrode material comprises sulfur and, in another example, the positive electrode material comprises sulfur and phosphorous. Examples of suitable temperature ranges for the reservoirs and reaction chamber for a LiPS battery include the ranges discussed above with reference to the LiS battery 300 of FIG. 3.

Therefore, for the example discussed with reference to FIG. 3, the fire danger of a lithium thermal battery is minimized by using a lithium salt mixture solid electrolyte. The lithium salt mixture provides the appropriate electrochemical properties for use as an electrolyte in a thermal lithium battery such as LiS battery while having a melting point adequately above the melting point of lithium, the melting point of sulfur, and the eutectic melting point of lithium polysulfide products (LiₙSₘ). In addition, the lithium salt mixture solid electrolyte is chemically stable with lithium and sulfur as well as with Li₂Sₘ species. The proportions of the salts of the eutectic salt system mixture are adjusted to set the melting point of the electrolyte material above the operating temperature range of the battery. Within the operating temperature range, therefore, the lithium salt mixture electrolyte remains solid but exhibits more plastic deformation than glass and more than a ceramic such as BASE because its operating temperature is much closer its melting point.

In some circumstances, therefore, the selection of materials and operational temperature ranges for use in the thermal battery are at least somewhat based on the melting point of the electrolyte material. A useful ratio of a material's temperature is the homologous temperature, T_{H}. The homologous temperature is the ratio of the material's absolute temperature to its absolute melting point temperature. The homologous temperature is very useful because materials behave in similar ways when heated. For instance, when a material's temperature is much lower than its melting point temperature, the material is typically hard and its creep rate under stress is negligible. However, when a material's temperature approaches its melting point, then the material softens and its creep rate under stress increases. As an example, the homologous temperatures for the BASE and sodium borate glass solid electrolyte in a sodium-sulfur battery operating at 350° C. are 0.27T_{MP} and 0.32T_{MP} respectively. At these homologous temperatures, the BASE and sodium borate glass are hard and exhibit a negligible creep rate under stress. By selecting a combination of materials that result in an operating temperature where at least one electrode is fluid and the electrolyte material is below, but relatively near, its melting point, the solid electrolyte is less brittle and more effectively separates and seals the electrode materials from each other. In most circumstances, the low end of the operating temperature range is at least above 35 percent of the absolute melting point of the solid electrolyte (i.e., T_{H} of the solid electrolyte is 0.35T_{MP}). As the low end of the operating temperature range is increased, the electrolyte is likely to have an increased softness and be less brittle. Therefore, the low end may be above 50, 60, 70, or 80 percent of the absolute melting point of the electrolyte (i.e., T_{H}=0.5T_{MP}, 0.6T_{MP}, 0.7T_{MP}, 0.8T_{MP}). In many circumstances, the high end of the operating temperature range may be limited by the boiling point of one of the electrode materials. In order to avoid having the electrode entering the gas phase, the high end of the operating temperature range should at least be lower than the lower boiling points of the positive electrode material and the negative electrode material. In some circumstances, the high end can be less that 98 percent of the lowest electrode material's absolute boiling point. In still other situations, the high end can be less than 95 percent of the lowest temperature of the electrode materials' absolute boiling points.

In some situations, the performance of the thermal battery is further improved by improving the ion-transport characteristics of the solid electrolyte. The improved solid electrolyte comprising a mixture of a plurality of salts and has a lattice that includes atomic scale defects that improve the ion-transport characteristics of the salt mixture solid electrolyte. In one example, the defects are due to the introduction of nanoparticles that result in grain boundary defects and/or sustain existing grain boundary defects. The change in bonding, vacancies, and other defects resulting at the grain boundaries with the nanoparticles improve the ion transport characteristics of the electrolyte. As discussed below, the introduction of nanoparticles can minimize the dissipation of previously formed defects in an effect sometimes referred to as “pinning”. Such previously formed defects may be formed during the synthesis process and also improve the ion transport characteristics. In another example, the defects originate from aliovalent substitution in the lattice. In examples of salt mixtures that include lithium cations (Li⁺), an aliovalent cation substitution with the lithium cation (Li⁺) creates an aliovalent substitution defect in the lithium salt lattice. For instance, introducing a barium cation (Ba²⁺) that is aliovalent to the lithium cation (Li⁺) creates an aliovalent substitution defect in the lithium salt lattice. In order to maintain charge neutrality in the lattice, two lithium cations are replaced by a single barium cation creating the defect in the lattice possibly a vacancy in one of the original lithium cation positions. Therefore, one or more materials may be introduced to the lithium salt lattice to form grain boundary defects, maintain existing defects, and/or to create aliovalent substitution defects to improve the ion transport characteristics of the lattice. The increased ion transport resulting from the introduction of defects may influence the selection of the salts for the salt mixture. For example, a relatively more expensive salt having an anion resulting is greater ion transport may be replaced with a less expensive salt when defects sufficiently increase the ion transport of the solid electrolyte.

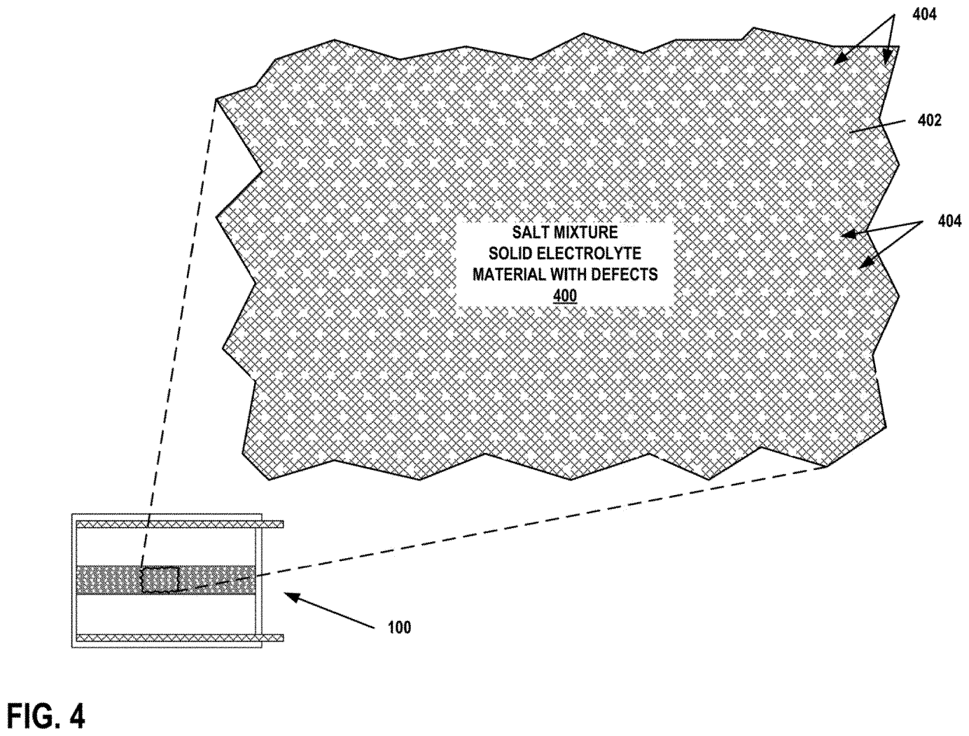

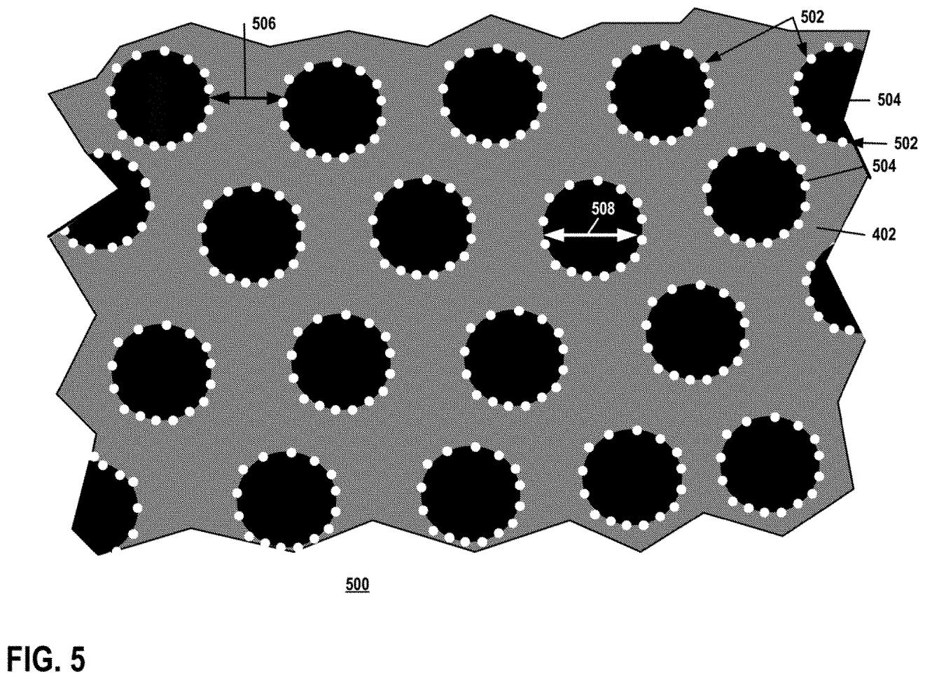

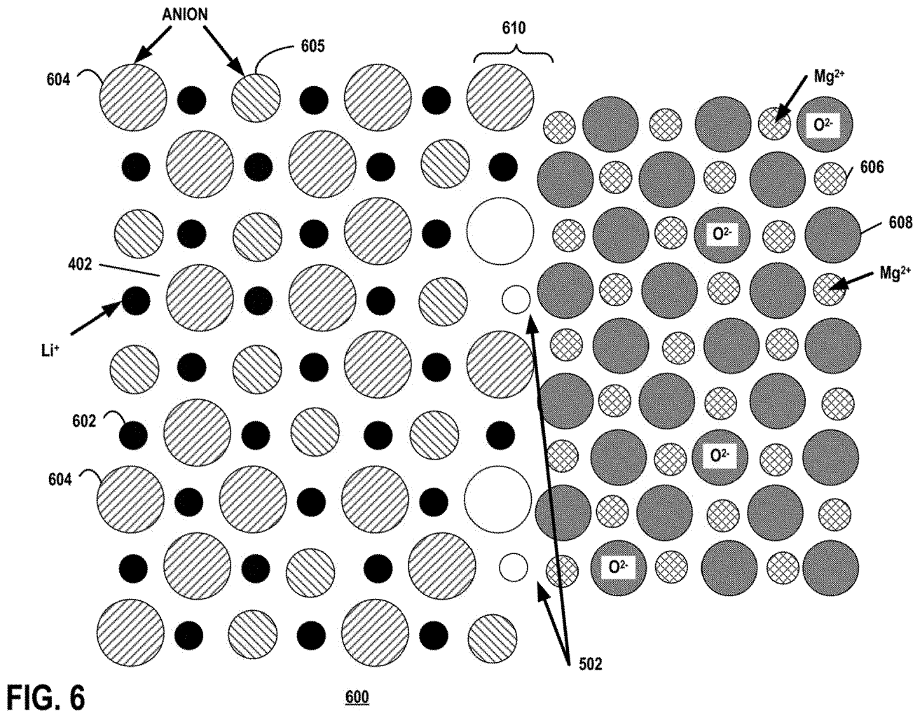

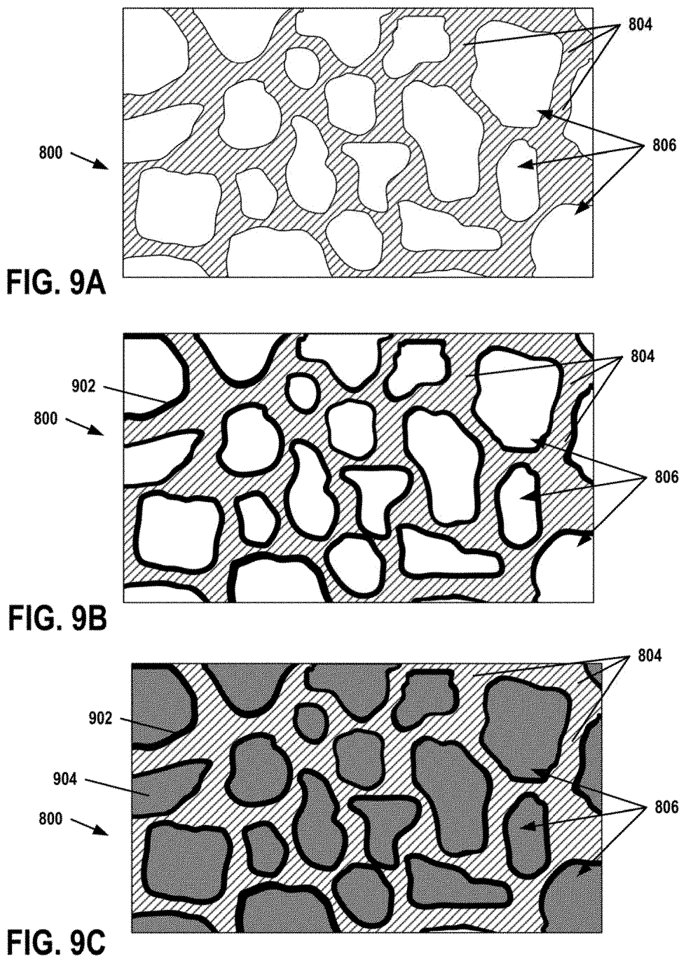

FIG. 4 is an illustration of an example of a portion 400 of a lithium salt mixture solid electrolyte material with lattice defects. Accordingly, the material 400 is an example of a material that comprises a mixture of salts as discussed above where defects are introduced into the salt lattice. The material 400 is an example of the material that can be used in the examples of the apparatus and battery discussed above. FIG. 4 is a visual representation of the portion of material and is not necessarily intended to represent distances or sizes to scale or accurately depict the shapes of the components that are discussed. The solid electrolyte material 400 includes a lithium salt lattice 402 formed by at least lithium cations and anions. The lattice 402 is represented by crosshatching in FIG. 4. A plurality of defects 404 are distributed within the lattice 402. As is known, crystalline solids exhibit a periodic crystal structure. The positions of atoms or molecules occur on repeating fixed distances, determined by the unit cell parameters. By introducing impurities, the arrangement of atoms or molecules in the lattice is no longer perfect. The regular patterns are interrupted by defects. In accordance with the techniques discussed herein, the pattern of the lithium salt lattice structure is disrupted by introducing other materials. In one example, as discussed with reference to FIG. 5 and FIG. 6, the defects relate to the introduction of nanoparticles. In some situations, the introduction of nanoparticles results in grain boundary defects. Additionally or alternatively, existing grain boundary defects in the lattice may be stabilized with nanoparticles. Such a result, sometimes referred to as “pinning,” occurs where existing grain boundary defects, that otherwise might have dissipated over time, are more easily sustained due to the introduction of the nanoparticles. The bond changes, vacancies and other defects resulting or sustained at the grain boundaries with the introduction of the nanoparticles improve the ion transport characteristics of the electrolyte. In another example, discussed with reference to FIG. 9, the defects are aliovalent substitution defects. A cation that is aliovalent to the lithium cation (Li⁺), such as a barium cation (Ba²⁺), creates an aliovalent substitution defect in the lithium salt lattice. In order to maintain charge neutrality in the lattice, two lithium cations are replaced by a single barium cation creating the defect in the lattice potentially at a vacancy at one of the original lithium cation locations.

FIG. 5 is an illustration of a portion 500 of the lithium salt mixture solid electrolyte 400 for an example where the plurality of defects 502 is a plurality of grain boundary defects that may be due to dangling bonds, changes in bonding, vacancies, and other defects occurring at the grain boundary. FIG. 5 is a visual representation of the portion of material and is not necessarily intended to represent distances or sizes to scale or accurately depict the shapes of the components that are discussed. A dangling bond is an unsatisfied valence on an immobilized atom. An atom with a dangling bond is also referred to as an immobilized free radical or an immobilized radical, a reference to its structural and chemical similarity to a free radical. On a surface of a material, dangling bonds occur because the atoms of the normal lattice no longer continue in space. By introducing a nanoparticle into the lithium salt lattice, dangling bonds and other defects can be formed at the boundary between the nanoparticle and the lattice material. In FIG. 5, the incorporated nanoparticles 504 are represented by larger black circles while the smaller white circles at the interface between the nanoparticle and the lithium salt lattice represent the grain boundary defects 502 formed by the introduction of the nanoparticles into the lithium salt lattice. In order to maximize the improvement in ion transport characteristics, the distance 506 between nanoparticles is minimized. As the distance 506 is reduced, however, the structural integrity of the lattice 402 is also reduced. As a result, for the example, the distance 506 between nanoparticles 504 is not minimized beyond the point where the structural integrity of the lattice is significantly compromised and the material is not suitable for use as a solid electrolyte in a thermal battery. For the example of FIG. 6, magnesium oxide nanoparticles are incorporated into the lithium salt lattice 402. For the examples discussed herein, the nanoparticles are on the order of 20 nm in size or approximately 200 bond lengths. Other nanoparticle sizes and materials may be used in some situations. Examples of other nanoparticle materials include Boron nitride (BN), Calcium oxide (CaO), Tantalum(III) oxide (Ta₂O₃), Samarium (III) oxide (Sa₂O₃), Lithium oxide (Li₂O). Beryllium oxide (BeO), Terbium(III) oxide (Tb₂O₃), Dysprosium (III) oxide (Dy₂O₃), Thorium dioxide (ThO₂), Gadolinium(III) oxide (Gd₂O₃), Erbium(III) oxide (Er₂O₃), Yttrium(II) oxide (Y₂O₃), Lithium chloride (LiCl), Holmium(III) oxide (Ho₂O₃), Neodymium(III) oxide (Nd₂O₃), Ytterbium(III) oxide (Yb₂O₃), Lanthanum(III) oxide (La₂O₃), Praseodymium(III) oxide (Pr₂O₃), Lithium fluoride (LiF), Lutetium(III) oxide (Lu₂O₃), Scandium(III) oxide (Sc₂O₃), Thulium (III) oxide (Tm₂O₃), Samarium(III) oxide (Sm₂O₃), Cerium(III) oxide (Ce₂O₃), and Mendelevium(III) oxide (Md₂O₃). Other potential nanoparticle materials that may be suitable for use with lithium iodide include Barium oxide (BaO), Strontium oxide (SrO), Magnesium fluoride (MgF₂), Cerium(IV) oxide (Ce₂O), Uranium(IV) oxide (U₂O), Europium (III) oxide (EuO), Zirconium dioxide (ZrO₂), Sodium fluoride (NaF), Europium(III) oxide (Eu₂O₃), Chrysoberyl (BeAl₂O₄), Calcium silicate (Ca₂SiO₄), Hafnium(IV) oxide (HfO₂), Calcium titanate (CaTiO₃), Ca₂Al₂SiO₇, Magnesium aluminate (MgAl₂O₄), Kalsilite (KAlSiO₄), Magnesium Metasilicate (MgSiO₃), CaMg(SiO₄)₂, Ca₃MgSi₂O₇, Merwinite (Ca₃Mg(SiO₄)₂), Calcium silicate (CaSiO₃). In some situations, more than one type of nanoparticle material can be used. Also, some materials may more easily dissolve in the particular lithium salt mixture and selection of the nanoparticles may be at least partially based on how easily the material dissolves in the lithium salt mixture.

FIG. 6 is an illustration of a portion 600 of the lithium salt mixture solid electrolyte with defects for an example where the nanoparticle material is magnesium oxide (MgO). FIG. 6 is a visual representation of the portion of material and is not necessarily intended to represent distances or sizes to scale or accurately depict the shapes of the components that are discussed. In the interest of clarity, the illustration is a two-dimensional model and does not show the ions extending from the plane of the drawing. Further, the illustration is a portion of the solid electrolyte emphasizing the interface between the nanoparticle and the lithium salt lattice and, as result, only includes representations of a few ions. In FIG. 6, the lithium cations (Li⁺) 602 are represented with black circles, the anions 604, 605 are represented with single crosshatched circles, the magnesium cations (Mg²⁺) 606 are represented with double crosshatched circles and the oxide anions (O²⁻) 608 are presented with shaded circles. The anions 604 of a first salt are represented with larger circles having areas crosshatched upward from left to right and the anions 605 of second salt are represented with smaller circles having areas crosshatched downward from left to right to indicate that the anions of the salts in the mixture may be different and have different sizes. A plurality of defects 502 form at the grain boundary 610. The defects 502 are represented by clear circles in FIG. 6 to indicate a disruption of the lithium salt lattice.

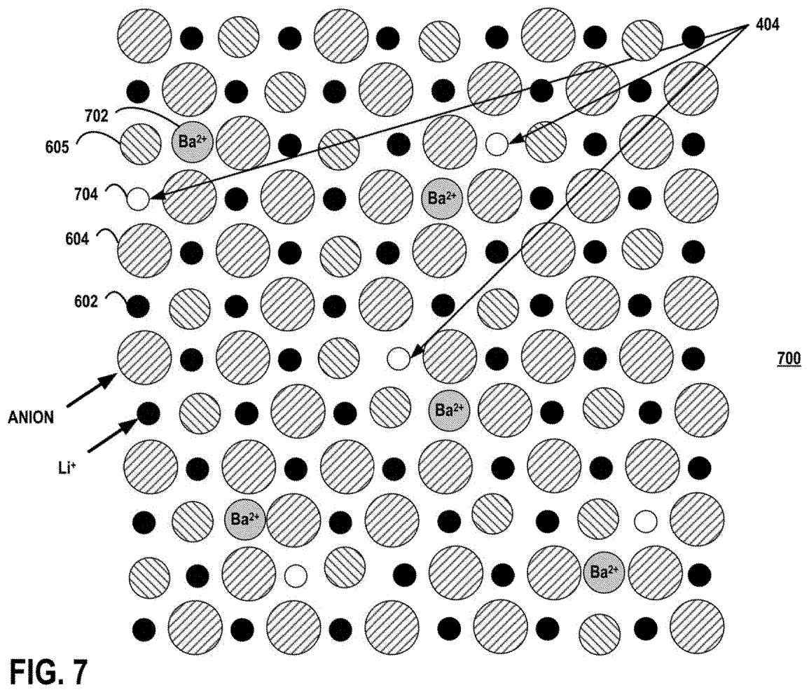

FIG. 7 is an illustration of an example of a portion 700 of the solid lithium salt mixture electrolyte material 400 including aliovalent substitution 702 that induces an aliovalent substitution defect 704. FIG. 7 is a visual representation of the portion of material and is not necessarily intended to represent distances or sizes to scale or accurately depict the shapes of the components that are discussed. In the interest of clarity, the illustration is a two-dimensional model and does not show the ions extending from the plane of the drawing. Further, the illustration is a portion of the solid electrolyte emphasizing the interface between the introduced defect-causing ions and the lithium salt lattice and, as a result, only includes representations of a few ions. In FIG. 7, the lithium cations (Li⁺) 602 are represented with black circles, the anions 604 are presented with single crosshatched circles, and the defect causing ions 702 are represented with shaded circles. The defects 704 (404) are represented by clear circles in FIG. 7 to indicate a disruption of or defect in the lithium salt lattice. For the example of FIG. 7, the defect causing ions are barium cations (Ba²⁺). The barium cations induce defects in the lattice structure for the lithium salt mixture. Generally, a defect causing ion is incorporated at a regular atomic site in the lattice structure. This regular atomic site is not a vacant site and the ion is not on an interstitial site. These disruptions in the normal crystal structure are typically referred to as substitutional defects. Substitutional defects may be isovalent substitution defects or aliovalent substitution defects. Isovalent substitution occurs where the ion that is substituting the original ion is of the same oxidation state as the ion it is replacing. Aliovalent substitution occurs where the ion that is substituting the original ion is of a different oxidation state than the ion that it is replacing. For the example herein, the barium cation results in an aliovalent substitution since it has a +2 charge and lithium has a +1 charge. Aliovalent substitutions change the charge at specific lattice locations within the material, but the overall material must remain charge neutral. Therefore, a charge compensation mechanism is required. As a result, either one of the metals is partially or fully oxidized or reduced, or ion vacancies are created. For the example, barium cations create aliovalent substitution defects 704 since the barium cation replaces two lithium cations. The +2 charged barium cation replaces a single charged lithium cation and, since charge neutrality in the lattice is maintained, a defect 704 occurs.

In some situations, the lithium salt mixture solid electrolyte with defects is reinforced with a reinforcing structure. The reinforcement structure is a porous structure of a material that is different from the lithium salt mixture solid electrolyte and has characteristics that provide an improvement to the resulting reinforced solid electrolyte over a solid electrolyte without a reinforcing structure. Such a technique, for example, can be used to increase the toughness and strength of the solid electrolyte material when formed into a reinforced solid electrolyte with defects. Some examples of reinforcing structures include meshes and foams of different materials, such as metal foams, ceramic foams, glass foams, woven wire meshes, and fiberglass meshes. Other types of reinforcing structures can be used in some situations. For the example discussed below, the reinforcing structure is an open cell metal foam. In situations where the reinforcement structure is electrically conductive, a dielectric material can be deposited onto the structure to transform the overall structure from electrically conductive to non-electrically conductive. Such a technique minimizes the likelihood of electrically short circuiting the cell. In some situations, a coating may be required to protect the reinforcement structure from chemical attack.

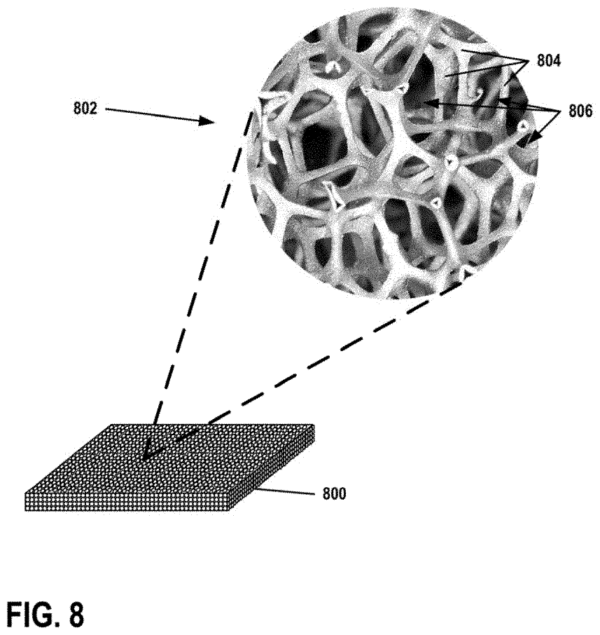

FIG. 8 is an illustration of an example of a block of open cell metal foam 800 suitable for use with the solid electrolyte within a thermal battery. A magnified view of the foam structure 802 in the example reveals a metal structure with metal structure components 804 separated by pores (open spaces) 806. The metal foam for the example has an open cell structure where the pores 806 between the metal components 804 of the metal foam 800 are interconnected. For the example, the material used for the metal foam has a melting point above the melting point of the lithium salt mixture. As a result, the lithium salt mixture can be heated to a fluid state and can be permeated throughout the metal foam without melting the metal foam. For the example, the metal foam is carbon steel although other materials may be used in some circumstances. Examples of other suitable materials include cast iron, low alloy steels, stainless steels, such as SS316, SS304, and SS410, Ti alloys, Ni alloys, W alloys, niobium, vanadium, molybdenum, ceramics (e.g. silicon carbide (SiC), B₄C, magnesia (MgO), calcium oxide (CaO), boron nitride (BN), zirconia, cordierite, alumino-silicates, Macor®, Mullite, and aluminum nitride (AlN)), graphite, carbon, Steatite L-5, quartz, sapphire, silicon, silica glass, soda glass, borosilicate, brick, stone, and concrete. Accordingly, reinforcing structures other than metal foams can be used in some circumstances although carbon steel foam is used for the example.

FIG. 9A is an illustration of an example of a cross section of the metal foam 800. The pores 806 within the metal foam 800 and between the metal structure components 804 are interconnected in the open cell structure. Typically, metal foams are characterized by porosity and pore density, such as pores per inch (ppi). Although other pore densities can be used, an example of a suitable pore density is in the range between 25 ppi and 500 ppi. For the example, the metal foam has density of approximately 100 ppi. Generally, metal foams have a relatively high porosity where 5-25% of the volume is the base metal. The metal foam may be manufactured using any of numerous techniques. One example includes the powder method where space holders are used to occupy the pore spaces and channels. During the casting processes, foam is cast with an open celled polyurethane foam skeleton. Therefore, metal in a powder form is poured into a polyurethane foam skeleton and heated to anneal the metal together and to burn out the polyurethane.

FIG. 9B is an illustration of an example of a cross section of the metal foam 800 after a dielectric material 902 has been deposited to the metal foam structure. The dielectric material 902 is deposited onto the metal foam using known techniques. For example, the dielectric material can be deposited using chemical vapor deposition techniques. Other examples include molten salt electrochemical deposition, atomic layer deposition (ALD), and physical vapor deposition (PVD). The dielectric material 902 is stable with the other battery components at least within the operating temperature range. For the example, the dielectric material is magnesium oxide (MgO). Examples of other dielectric materials include Boron nitride (BN), Calcium oxide (CaO), Tantalum(III) oxide (Ta₂O₃), Samarium (III) oxide (Sa₂O₃), Lithium oxide (Li₂O), Beryllium oxide (BeO), Terbium(III) oxide (Tb₂O₃), Dysprosium (III) oxide (Dy₂O₃), Thorium dioxide (ThO₂), Gadolinium(III) oxide (Gd₂O₃), Erbium(III) oxide (Er₂O₃), Yttrium(III) oxide (Y₂O₃), Lithium chloride (LiCl), Holmium(III) oxide (Ho₂O₃), Neodymium(III) oxide (Nd₂O₃), Ytterbium(III) oxide (Yb₂O₃), Lanthanum(III) oxide (La₂O₃), Praseodymium(III) oxide (Pr₂O₃), Lithium fluoride (LiF), Lutetium(III) oxide (Lu₂O₃), Scandium(III) oxide (Sc₂O₃), Thulium (III) oxide (Tm₂O₃), Samarium(III) oxide (Sm₂O₃), Cerium(III) oxide (Ce₂O₃), and Mendelevium(III) oxide (Md₂O₃). Other potential dielectric materials that may be suitable for use with a lithium salt mixture and the metal foam include Barium oxide (BaO), Strontium oxide (SrO), Magnesium fluoride (MgF₂), Cerium(IV) oxide (Ce₂O), Uranium(IV) oxide (U₂O), Europium (II) oxide (EuO), Zirconium dioxide (ZrO₂), Sodium fluoride (NaF), Europium(III) oxide (Eu₂O₃), Chrysoberyl (BeAl₂O₄), Calcium silicate (Ca₂SiO₄), Hafnium(IV) oxide (HfO₂), Calcium titanate (CaTiO₃), Ca₂Al₂SiO₇, Magnesium aluminate (MgAl₂O₄), Kalsilite (KAlSiO₄), Magnesium Metasilicate (MgSiO₃), CaMg(SiO₄)₂, Ca₃MgSi₂O₇, Merwinite (Ca₃Mg(SiO₄)₂), Calcium silicate (CaSiO₃). These ceramics are typically less vulnerable to chemical attack from the components of the thermal lithium battery and are typically not electrically conductive although the conductivity may increase with temperature. Therefore, selection of the ceramic materials may be based on the electrical conductivity and susceptibility to chemical attack at the operating temperature range of the battery. In some situations, more than one type of dielectric material can be used. For the example of the metal foam, a dielectric is used to insulate the conductive metal from the electrodes to avoid electrical short circuits through the electrolyte structure as well as to protect the metal foam from chemical attack from molten lithium, sulfur, and di-lithium polysulfide products. In some situations, a dielectric coating protects the reinforcing structure from a chemical attack from other components within the battery, such as molten lithium, sulfur, and di-lithium polysulfide products. Even in situations where a non-conductive material is used for the reinforcing structure, the reinforcing structure may be coated with a dielectric material to protect the structure from chemical attack from molten lithium and/or molten sulfur and/or di-lithium polysulfide products. For example, a coating may be useful with reinforcing structures containing ceramics, such as alumina, silicon carbide, and others discussed below. The dielectric materials discussed above may be used to coat such materials to protect them from chemical attack from the molten lithium, molten sulfur and/or molten di-lithium polysulfide products.

As mentioned above, ceramics can be used for the reinforcing structure material. Examples of some ceramics that can be used in some situations include Magesium oxide (MgO), Boron nitride (BN), Calcium oxide (CaO), Tantalum(III) oxide (Ta₂O₃), Samarium (III) oxide (Sa₂O₃), Lithium oxide (Li₂O), Beryllium oxide (BeO), Terbium(III) oxide (Tb₂O₃), Dysprosium (III) oxide (Dy₂O₃), Thorium dioxide (ThO₂), Gadolinium(III) oxide (Gd₂O₃), Erbium(III) oxide (Er₂O₃), Yttrium(III) oxide (Y₂O₃), Lithium chloride (LiCl), Holmium(III) oxide (Ho₂O₃), Neodymium(III) oxide (Nd₂O₃), Ytterbium(III) oxide (Yb₂O₃), Lanthanum(III) oxide (La₂O₃), Praseodymium(III) oxide (Pr₂O₃), Lithium fluoride (LiF), Lutetium(III) oxide (Lu₂O₃), Scandium(III) oxide (Sc₂O₃), Thulium (III) oxide (Tm₂O₃), Samarium(III) oxide (Sm₂O₃), Cerium(III) oxide (Ce₂O₃), Mendelevium(III) oxide (Md₂O₃). These ceramics are typically less vulnerable to chemical attack from the components of the thermal lithium battery and are typically not conductive although the conductivity may increase with temperature. Therefore, selection of the ceramic materials may be based on the electrical conductivity and susceptibility to chemical attack at the operating temperature range of the battery. As a result, a dielectric coating may not need to be applied with at least some of these materials. Nonetheless, a coating may be applied for other reasons.

Other ceramics that may be used for reinforcing structure material in some situations include Barium oxide (BaO), Strontium oxide (SrO), Magnesium fluoride (MgF₂), Cerium(IV) oxide (Ce₂O), Uranium(IV) oxide (U₂O), Europium (II) oxide (EuO), Zirconium dioxide (ZrO₂), Sodium fluoride (NaF), Europium(III) oxide (Eu₂O₃), Chrysoberyl (BeAl₂O₄), Calcium silicate (Ca₂SiO₄), Hafnium(IV) oxide (HfO₂), Calcium titanate (CaTiO₃), Ca₂Al₂SiO₇, Magnesium aluminate (MgAl₂O₄). Kalsilite (KAlSiO₄), Magnesium Metasilicate (MgSiO₃), CaMg(SiO₄)₂, Ca₃MgSi₂O₇, Merwinite (Ca₃Mg(SiO₄)₂), and Calcium silicate (CaSiO₃). A coating may be useful for these ceramics since at least some may be vulnerable to chemical attack from the components of the thermal lithium battery or may become electrically conductive at the operating temperature of the battery.

Examples of ceramics that may be used for the reinforcing structure material that likely require a coating include Tantalum carbide (TaC), Tantalum nitride (TaN), Tantalum diboride (TaB₂), Tungsten carbide (WC), Tungsten diboride (WB₂), Hafnium carbide (HfC), Hafnium nitride (HfN), Hafnium diboride (HfB₂), Zirconium carbide (ZrC), Zirconium nitride (ZrN), Zirconium diboride (ZrB₂), Silicon carbide (SiC), Silicon nitride (Si₃Ni₄), Niobium carbide (NbC), Niobium nitride (NbN), Niobium diboride (NbB₂), Titanium carbide (TiC), Titanium nitride (TiN), Titanium diboride (TiB₂), Vanadium carbide (VC), Vanadium nitride (VN), Boron carbide (B₄C), Aluminum Nitride (AlN), Alumina (Al₂O₃), and Silica (SiO₂). Selection of materials for use in the battery is based on several factors, such as the melting points of the material and other materials in the battery, likelihood of reaction with other battery materials at the operating temperature, conductivity of the material at the operating temperature, and how easily the material dissolves in the lithium salt mixture and Li. Other design factors for selecting the material may include cost, density, and toxicity, as well as others.

FIG. 9C is an illustration of an example of a cross section of the dielectric coated metal foam 800 after the lithium salt mixture 904 has been flowed, poured or otherwise deposited into the metal foam. During formation of the reinforced solid electrolyte, the molten lithium salt mixture with defects is flowed into the metal foam 800. After pores 806 are filled with the liquid lithium salt mixture that includes grain boundary defects and/or aliovalent substitution defects, the materials are allowed to cool to form the reinforced solid electrolyte with defects. In some situations, the metal foam is filled with nanoparticles before the liquid lithium salt mixture is deposited in the foam structure. In yet other situations, solid particles of the lithium salt mixture comprising defects are poured into the metal foam 800, then heated to anneal or melt the lithium salt mixture comprising defects in place, and finally, allowed to cool.

Other examples of techniques for fabricating the open cell foam include pyrolyzing a polymer foam to create a reticulated vitreous carbon foam which is then infiltrated by refractory metals or ceramics. The metal or ceramic materials are selected to achieve the desired properties of the foam. Such infiltrated pyrolyzed polymer foam techniques may be particularly useful where the thickness of the foam requires a greater pore density to achieve a required foam strength. As the thickness of the foam is reduced, for example, larger pores may not provide a sufficient pore density to achieve the adequate foam strength for the thinner foam. These infiltrated pyrolyzed polymer foam techniques allow for the fabrication of foams with smaller pores and higher pore densities.

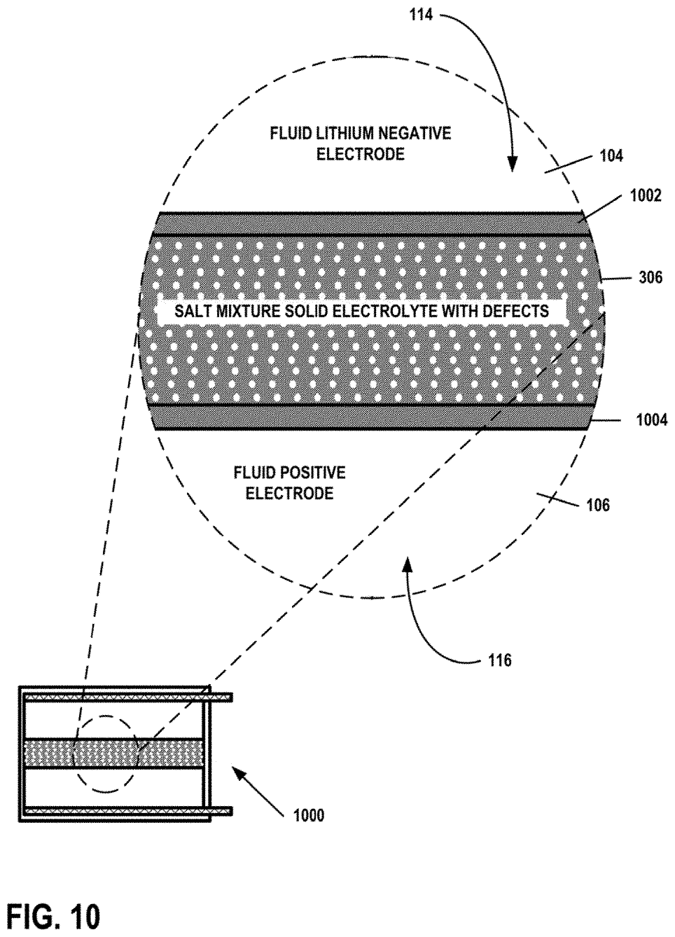

FIG. 10 is an illustration of an example of a thermal battery 1000 with a lithium salt mixture solid electrolyte with defects (306) that includes protective layers 1002, 1004 between the electrolyte 306 and the electrodes 104, 106. The protective layers 1002, 1004 protect the solid electrolyte from chemical attack by materials in the electrodes and comprise a lithium salt for the example. The large dashed oval in FIG. 10 provides a close-up view of a portion of the battery 1000 near the solid electrolyte 306. The battery 1000 differs from the batteries discussed above in that the battery includes the additional protective layers 1002, 1004. The battery 1000 of FIG. 10, therefore, is an example of the apparatus 100 and or battery 300 where protective layers 1002, 1004 are interposed between the electrodes 104, 106 and the electrolyte 306. The protective layers 1002, 1004 include minimal amounts, if any, of materials that are reactive with, or otherwise susceptible to chemical attack from, electrode materials at the operating temperatures of the battery. In one situation, for example, the protective layers are a high purity lithium salt or a high purity lithium salt mixture and do not include any additional materials. At a minimum, the concentration of materials that are reactive with either electrode material is significantly less than the concentrations that may be found in the lithium salt mixture solid electrolyte with defects 306. In other situations, the protective layers include additional materials that are not reactive with the electrode materials at the operating temperatures of the battery. For example, materials may be added to the protective layers to introduce or maintain defects where the additional materials are not reactive with the electrode materials. Therefore, the protective layers may include defects formed or pinned by materials other than materials in the solid lithium salt mixture electrolyte 306. Such a structure may be useful where the electrolyte with defects includes materials that may be reactive with one or both of the electrode materials. For example, a ceramic, such as alumina can be introduced in the electrolyte without coating the alumina while minimizing the potential for reaction between the fluid lithium and the alumina in the electrolyte. The protective layers, therefore, form inert coatings on the salt mixture solid electrolyte with defects 306 allowing the salt mixture solid electrolyte 306 to include nanoparticles, such as alumina, zirconia, titanium oxide that are mechanically sound at the operating temperature and stable with respect to the lithium salt mixture yet are vulnerable to chemical attack by an electrode material, such as molten lithium. With the protective layers, the solid electrolyte may include aliovalent substitution defects formed by materials, such as Sr²⁺ and Al³⁺ which are vulnerable to chemical attack by an electrode material, such as molten lithium and may not be highly mobile in the lithium salt lattice. Cations that are highly mobile in the lattice are likely to diffuse through the Li salt coatings and potentially dissolve into the molten lithium electrode. Over time, the number of aliovalent substitutions could diminish resulting in fewer defects and poorer performance of the Li⁺ transport through the electrolyte.

The protective layer, therefore, provides a chemically insulating layer between the electrode material and the electrolyte. The protective layers could have a defect concentration of zero or near zero where for example, the protective layers include only high purity lithium salt or high purity lithium salt mixture. In other situations, however, the protective layers may have high defect concentrations due to materials that are chemically resistant to the fluid electrodes.

For the example, each protective layer has a thickness on the order of 50 nm although other thicknesses may be used in some circumstances. Generally, the protective layer should have a sufficient thickness to provide the desired isolation between the electrode and the electrolyte without exceeding an acceptable level of impedance between the electrolyte and the electrode such that ionic transfer is not significantly impacted. In one example, the protective layers are deposited onto the lithium salt electrolyte with defects prior to exposing the electrolyte to the electrode materials. In another example, one or both of the layers are formed by exposing the electrolyte with defects to the electrode material. With such a technique, the electrode material could react with the introduced material within the electrolyte until a stable lithium salt layer or lithium salt mixture layer remains. For instance, a solid electrolyte of lithium salt with a concentration of alumina nanoparticles could be used. Once this solid electrolyte is exposed to molten lithium, the molten lithium reacts with the alumina nanoparticle to form aluminum and lithium oxide. The aluminum is likely to dissolve into the molten lithium thereby leaving a crater in the solid electrolyte. This process continues until the molten lithium has access only to the lithium salt mixture or lithium salt. This method sacrifices the top surface of the solid electrolyte, but effectively establishes a stable lithium salt surface or lithium salt mixture surface between the fluid electrode and the solid electrolyte. This method can also be used for defects associated with aliovalent substitutions, such as magnesium or calcium that are susceptible to chemical attack by molten lithium. In a typical situation, the concentration of these defect causing or defect sustaining materials is critical to the viability of this technique. For instance, if the concentration of alumina nanoparticles is too high, then the entire solid electrolyte could be destroyed by the molten lithium electrode. Although the example includes a protective layer between each electrode and the electrolyte interface, only a single layer may be used in some situations.

In situations where materials are introduced into the protective layers 1002, 1004 to generate defects or pin existing defects, the materials can be resistant to chemical attack from the electrode materials. In most situations, such protective layers can be thicker than protective layers composed of higher purity lithium salt or a higher purity salt mixture. The ion transport characteristics of protective layers with defects, for example, may be better than protective layers of higher purity lithium salt. As a result, a thicker protective layer with defects may have acceptable ion transport characteristics. This approach could be advantageous if the materials that generate defects or pin existing defects that are resistant to chemical attack from the electrodes are more expensive than the materials that generate defects or pin existing defects that are not resistant to chemical attack. For instance, magnesia (MgO) nanoparticles may be more expensive than alumina (Al₂O₃) nanoparticles. An example of a cost-effective implementation, therefore, includes using magnesia nanoparticles in the protective layer 1002 and using alumina nanoparticles in the solid lithium salt mixture electrolyte 306.

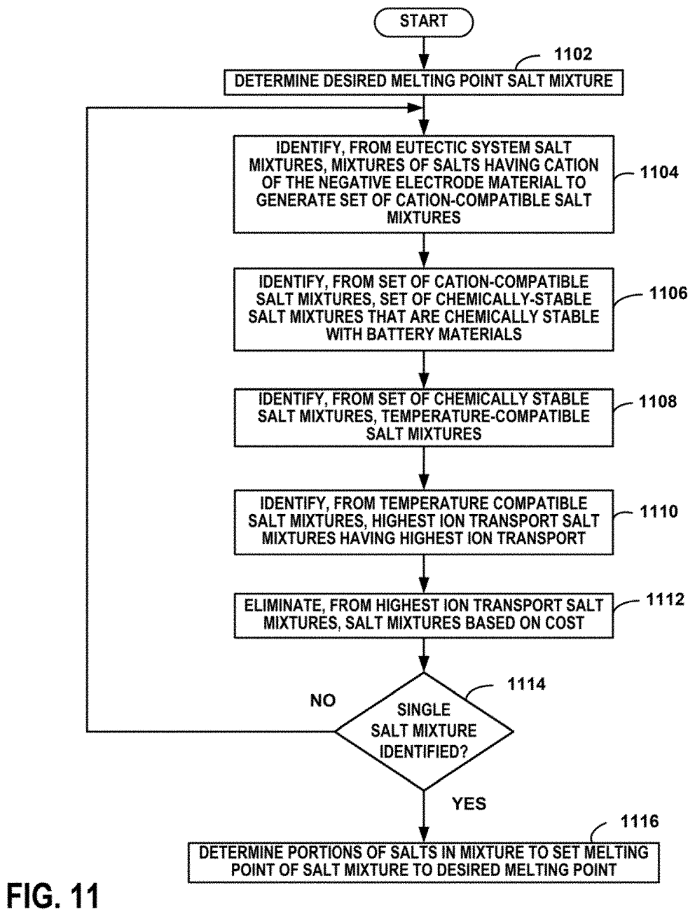

FIG. 11 is a flowchart of an example of a method of designing a salt mixture solid electrolyte for a high-temperature fluid electrode battery. The steps of FIG. 11 can be performed in a different order than shown and some steps may be combined into a single step. Additional steps may be performed and some steps may be omitted.

At step 1102, the desired melting point is determined. As discussed above, the desired melting point may be determined based on the upper temperature of the operating temperature range of the battery and a buffer to address potential undesired conditions. The buffer, if any, is determined based on possible conditions that may result in the battery exceeding the upper temperature of the operating range and the extent of potential temperature increase. Accordingly, factors that may be considered in determining the desired melting point, include the chemistry of the battery including characteristics of the materials, operating conditions, temperature control features, and potential conditions and events.

At step 1104, eutectic salt mixtures having a cation of the negative electrode material are identified. A set of cation-compatible salt mixtures are identified where each salt mixtures the set includes at least one salt that has the negative electrode cation. For an example where the negative electrode material comprises lithium, the set of cation-compatible salt mixtures include salt mixtures with at least one lithium salt. Some examples of eutectic salt mixtures including at least one lithium salt include LiCl—KCl, LiBr—KBr, LiI—KI, LiF—KF, LiF—LiI, LiBr—LiF, LiCl—LiI, LiF—LiCl, LiCl—NaCl, LiC—BaCl₂, NaBr—LiBr, NaI—LiI, LiF—LiCl—LiBr, LiF—LiBr—KBr, LiCl—LiBr—KBr, LiF—NaF—KF, LiCl—KCl—LiF, LiCl—KCl—LiBr, LiCl—KCl— NaCl, LiCl—KCl—LiI, LiCl—KCl—KI, NaI—LiI—KI, NaCl—LiCl—KCl, LiBr—LiCl—LiI, NaBr—LiBr—KBr, LiF—LiCl—LiI, LiCl—LiI—KI, NaCl—NaI—LiCl—LiI, NaCl—NaBr—LiCl—LiBr, NaBr—NaI—LiBr—LiI, and LiF—LiCl—LiBr—LiI.

At step 1106, a set of chemically-stable salt mixtures is identified. The set of cation-compatible salt mixtures is evaluated and all salt mixtures that are not chemically stable with the negative electrode material, the positive electrode material, and any other materials that may come in contact with the electrolyte are excluded. For the example, only the most chemically stable salts are identified to generate a chemically-stable salt mixture set.

At step 1108, a set of temperature-compatible salt mixtures is identified from the set of chemically-stable salt mixtures. The eutectic melting point of each salt mixture in the chemically-stable salt mixture set is compared to the desired melting point to identify the set of temperature-compatible salt mixtures that can be used within the particular battery. In some situations, only salt mixtures having a eutectic below the desired melting point are included in the set such that the melting point can be established by changing the composition of the salt mixture. In other situations, salt mixtures having a eutectic above, but near, the desired melting point are also included in the set. When selecting the temperature-compatible salt mixture, it may be advantageous to determine the slope of the phase diagram. For example, a salt mixture having a significant change in melting point for relatively small changes in composition may be less preferred due to the resulting tight tolerance.

At step 1110, the high ion transport salt mixtures are identified. A number of salt mixtures having the highest ion transport characteristics in the set of temperature-compatible salt mixtures are selected to further the limit of set of potential salt mixtures for use in the solid electrolyte. For situations where the negative electrode material comprises lithium, examples of high ion transport salt mixtures include LiCl—KCl, LiBr—KBr—LiCl, LiBr—KBr—LiF, and LiCl—LiBr—LiF.

At step 1112, the salt mixtures with acceptable cost are identified. Therefore, the set of potential salt mixtures for use in the electrolyte is further reduced by eliminating salt mixtures that are cost prohibitive or at least more expensive than other comparable salt mixtures.

At step 1114, it is determined whether single salt mixture remain in the set of salt mixtures under consideration. If only a single salt remains, the method continues at step 1116. Otherwise, the method returns to step 1108 where the set of salt mixtures under consideration is further reduced by applying steps 1108, 1110, and 1112 to the remaining salt mixtures under consideration.

At step 1116, the composition of the selected salt mixture is determined. The proportions of the salts in the salt mixture are selected to provide the desired melting point of the mixture. The multiple compositions of the mixture identified for the desired melting point from the phase diagram are evaluated to determine the preferred composition. Examples of factors that may be considered include the costs of the salts and the ion transport characteristics.

The techniques discussed herein can be applied to other high temperature batteries in addition to lithium sulfur batteries. Some examples of salt mixtures that can be considered for a sodium sulfur battery include NaCl—NaI, NaCl—NaBr, NaBr—NaI, NaCl—LiCl, NaBr—LiBr, NaI—LiI, NaCl—NaI—LiCl—LiI, NaCl—NaI, NaBr—LiCl—LiBr, NaBr—NaI—LiBr—LiI, NaCl—NaBr—NaI, NaCl—LiCl—KCl, NaBr—LiBr—KBr, NaI—LiI—KI, KCl—NaCl—CaCl₂, NaCl—KCl—BaCl₂—CaCl₂, NaCl—NaBr—LiCl—LiBr, LiF—NaF—KF, NaCl—MgCl₂, and KCl—NaCl—MgCl₂.

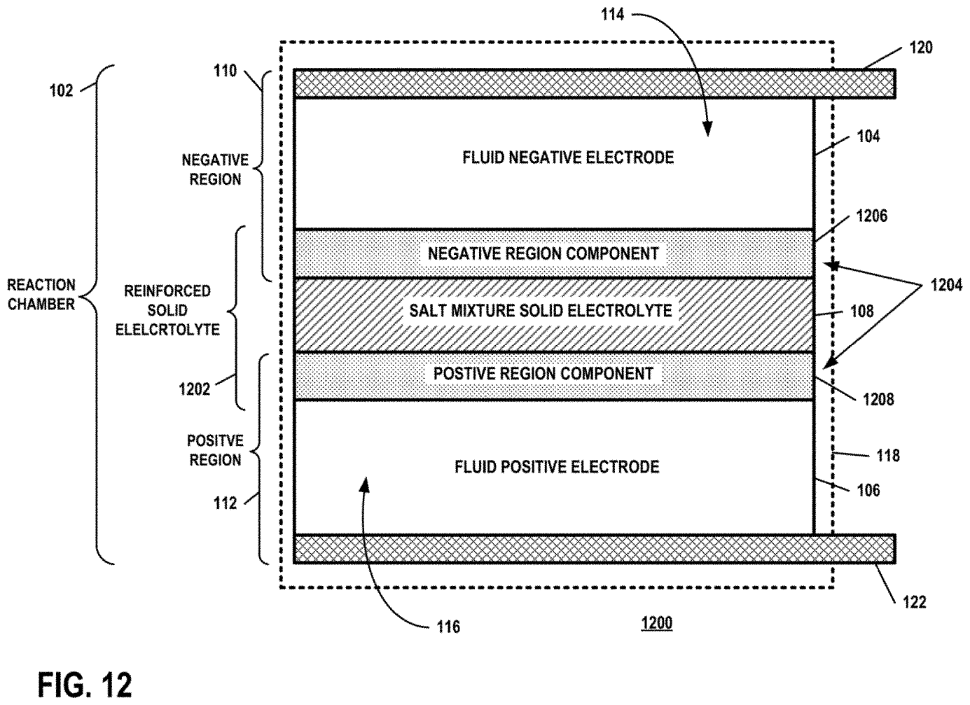

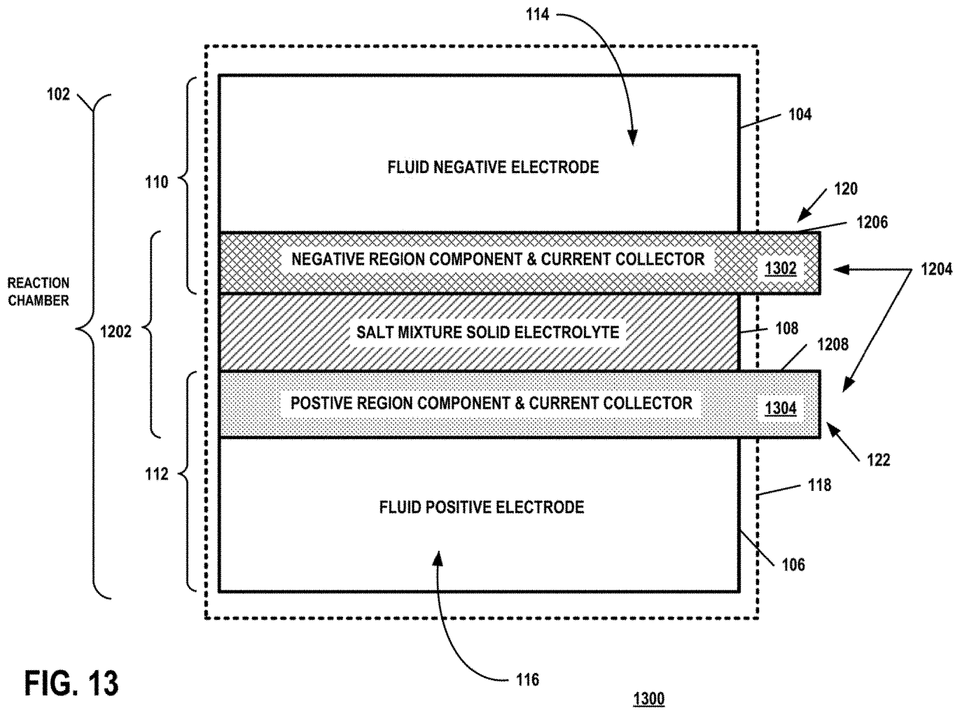

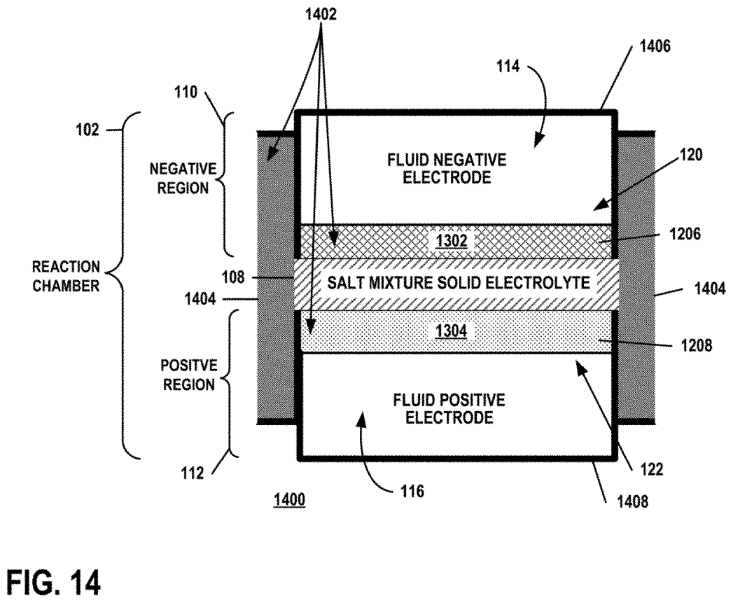

As discussed above, strength and integrity of the solid electrolyte is critical for safety in thermal batteries with molten electrodes. In addition, a thinner electrolyte provides higher current flow and power production with less internal heat generation. Thinner electrolytes, however, may be more susceptible to failure. For the examples of FIG. 12, FIG. 13 and FIG. 14, the safety of a thermal battery is maximized by using a reinforced solid electrolyte to separate the fluid molten electrodes. The reinforced solid electrolyte may provide several other advantages in addition to safety. The use of a thinner solid electrolyte results in increased current flow and higher power with less heat generation since resistance to ion flow through the electrolyte is reduced. With the increased flow, the rate of charging and discharging is increased which results in a battery that requires less time to charge and that has a higher rate of energy production. Since less solid electrolyte material is required, the cost and weight of battery is also reduced. Such advantages may be useful in numerous applications where some of the benefits may be more valuable in certain applications. For example, rapid charging capability, lower weight, and lower cost may be especially advantageous in electrical vehicles. Where the battery is used to power aerial vehicles, lower weight and higher power capability may be critical since takeoff and landing of such vehicles typically requires intense bursts of high energy from a lightweight power source where the weight of the battery directly and acutely impacts the payload capability and range of the vehicle.

For the examples herein, the reinforced solid electrolyte is formed with a reinforcing structure disposed adjacent to the solid electrolyte. In some situations, the reinforcing structure may be included only along a single side of the solid electrolyte. In other situations, the reinforcing structure includes two portions including a negative region component and a positive region component where the negative component is positioned between the solid electrolyte and the negative electrode and the positive component is positioned between the solid electrolyte and the positive electrode. In still other situations, a third component may be used along the edge of the solid electrolyte that is not facing either electrode. The third component may sometimes also function as a sealing component. As discussed below, for example, where a non-brittle electrolyte is formed with a material with a melting point higher, but relatively near, the operating temperature range of the battery, the third component of the reinforcing structure may provide support and seal the edge of the solid electrolyte. Since such a solid electrolyte maybe somewhat soft and yielding near its melting point, the solid electrolyte may be susceptible to movement, shifting, or other deformation when the apparatus is exposed to internal or external forces. In some situations, therefore, a third component of the reinforcing structure may provide additional structural support as well as provide a seal for the solid electrolyte.

At least the negative region component and the positive region component have an open geometry that allows electrode material to flow through the reinforcing structure. The negative region component and/or the positive region component may be electrically conductive in some circumstances. Although the third component may have an open structure in some situations, the third component does not typically have an open structure and has a geometry that prevents flow of materials through the third component in addition to having a structure that minimizes movement or deformation of the solid electrolyte. Additional components of the reinforcing structure may be used in still other situations which may depend on the geometry, shape, and size of the solid electrolyte as well as characteristics of other battery components.

As discussed above, the salt mixture solid electrolyte 108 has a melting point near the operating temperature range of the battery and is, therefore, in a solid state yet relatively soft within the operating temperature range of the battery. The reinforcing structure provides additional integrity and firmness to the solid electrolyte. As a result, the thickness of the solid electrolyte may be reduced with minimal impact on safety.

FIG. 12 is a block diagram of a cross-sectional view of an example of a battery apparatus 1200 including a reaction chamber 102 having fluid electrodes 104, 106 separated by a reinforced solid electrolyte 1202 including a salt mixture solid electrolyte 108 where the salt mixture solid electrolyte 108 is positioned between the electrodes 104, 106. The reinforced solid electrolyte 1202 includes a reinforcing structure 1204 positioned adjacent to the salt mixture solid electrolyte 108. The battery 1200 is an example of the apparatus 100 and battery 300 discussed above.

The illustration in FIG. 12 depicts some of the general principles of the example and does not necessarily represent specific shapes, relative sizes, distances, or other structural details of the represented components. In some circumstances, the structures of two or more blocks may be implemented in a single component or structure. In addition, functions described as performed in a single block of FIG. 12 may be implemented in separate structures. The orientation shown in the figures does not necessarily imply an orientation of the apparatus relative to the direction of gravity during operation. In some circumstances, for example, the fluid positive electrode may be positioned above the fluid negative electrode. The examples discussed with reference to FIG. 12, FIG. 13 and FIG. 14 include a salt mixture solid electrolyte 108. In some situations, the salt mixture solid electrolyte 108 may be a salt mixture solid electrolyte with defects 400 as discussed with reference to FIG. 4 and FIG. 10.

The battery 1200 includes at least the reaction chamber 102 having the negative electrode region 110 and the positive electrode region 112 separated from the negative electrode region 110 by the salt mixture solid electrolyte 108. For the example of FIG. 12, the reinforcing structure 1204 includes a negative region component 1206 in the negative electrode region 110 and a positive region component 1208 in the positive electrode region 112. In some situations, one of the components 1206, 1208 can be omitted. As discussed above, the negative electrode region 110 contains a negative electrode material 114 and the positive electrode region 112 contains a positive electrode material 116. The negative region component 1206 is positioned adjacent to, and in contact with, the salt mixture solid electrolyte 108 to provide mechanical support to the salt mixture solid electrolyte 108. The positive region component 1208 is adjacent to, and in contact with, the salt mixture solid electrolyte 108 to provide mechanical support to the salt mixture solid electrolyte 108. Since the reinforcing structure components 1206, 1208 have an open geometry, each fluid electrode material 114, 116 permeates the respective reinforcing structure component 1206, 1208. As a result, the reinforced solid electrolyte 1202 overlaps with each of the regions 110, 112. The negative fluid electrode 104 extends through the negative region component 1206 such that the negative fluid electrode 104 contacts the salt mixture solid electrolyte 108. The positive fluid electrode 106 extends through the positive region component 1208 such that the positive fluid electrode 106 contacts the salt mixture solid electrolyte 108. Where the solid electrolyte material has a melting point near the operating temperature of battery, the relatively soft solid electrolyte 108 may enter a small distance into the open geometry reinforcing structure at the interface between the solid electrolyte and the reinforcing structure.

In some situations, at least one of the reinforcing structure components extends more than a small distance into the salt mixture solid electrolyte 108. During manufacturing, the salt mixture solid electrolyte 108 may be heated to a sufficiently high temperature to allow the reinforcing structure to be partially implanted into the salt mixture solid electrolyte 108. Such a technique may allow for the reinforcing structure to introduce defects within the lattice of the solid electrolyte structure and to strengthen the solid electrolyte material in addition to providing mechanical support. In one example, the reinforcing structure is a single unit that extends from negative electrode, through the solid electrolyte, into the positive electrode. In such configurations, however, the reinforcing structure is electrically nonconductive. As a result, the material of the reinforcing structure is nonconductive or a nonconductive coating is applied to the electrically conductive material of the reinforcing structure.

As discussed below with reference to FIG. 13, the reinforcing structure components 1206, 1208 may be implemented to be current collectors in some situations. In situations where a reinforcing structure component functions as a current collector, the component is electrically conductive. At least one of the components 1206, 1208 of the reinforcing structure 1204, therefore, may be electrically conductive.

As mentioned above, other materials may be present within the open structure in some circumstances. For example, in implementations where the negative electrode includes lithium and the positive electrode includes sulfur, lithium-sulfur reaction products may form in the positive electrode region 112. In at least some situations, these reaction products form in the region between the solid electrolyte 108 and the positive current collector and, therefore, may be within the positive region reinforcing structure component 1208.

Although the materials of the negative region component 1206 and the positive region component 1208 may be the same in some circumstances, the material and structure of each component 1206, 1208 is selected based on particular environment where the component 1206, 1208 is positioned. The materials may be selected based on several factors including the electrode materials and at least some characteristics of the solid electrolyte 108. In many situations, the materials are selected based on cost, compatibility with other battery materials, and strength to weight ratio. The material of each of the negative region component 1206 and the positive region component 1208 are selected to be stable with the chemistry of the electrode material and any reaction products within the electrode region where the component is disposed. The reinforcing structure material is also selected to be chemically stable with the solid electrolyte material. Other factors that may be considered in selecting the material of the reinforcing structure 1204 include the strength, softness, brittleness of the solid electrolyte 108 where the characteristics of the salt mixture solid electrolyte 108 may be related to the thickness of the salt mixture solid electrolyte 108 and the level of any defects in the lattice of the solid electrolyte material such as those introduced with nanoparticles and aliovalent substitution in the lattice.

Additional factors that may be considered when selecting the structure and material include the level of expected forces on the salt mixture solid electrolyte 108 during operation of the battery including internal forces and as well as external forces exerted on the battery from the environment in which the battery is deployed. An example of an internal force on the reinforced solid electrolyte 1202 includes forces due to vapor pressure of at least one of the fluid electrodes. Examples of external forces include forces due to acceleration and deceleration of the battery during operation. Where the battery is deployed in an aerial vehicle, such as a military fighter jet, electric aerial fighter, or unmanned aerial vehicle (UAV), forces on the battery experienced during takeoff, landing, and in-flight maneuvers may be considered. Where the battery is deployed in a terrestrial vehicle such as an electric car, forces due extreme deceleration during a crash may be considered in addition to the forces that may be present during normal operation of the vehicle.

In some situations, one or more reinforcing structure components with an open geometry may include a coating material disposed on the surfaces of the structure. Such a coating may be selected based on characteristics such as the chemical stability with the electrode material and electrical conductivity.

The selection of the reinforcing structure material is also dependent on the structure/geometry, shape and size of the reinforcing structure components in the overall design of reinforcing structure. Examples of the factors that may be considered in selecting the shape and geometry include at least the examples discussed above regarding material selection. In most situations, the design of the reinforcing structure 1204 involves tradeoffs between the various factors, characteristics and objectives.

Generally, the material, size (including thickness), internal geometry (including the size of openings within the structure) of each component 1206, 1208 of the reinforcing structure 1204 are selected to optimize performance while maintaining a desired strength of the structure. In some situations, computer modeling is used to optimize electrode material flow, strength and other structural and performance characteristics of each component 1206, 1208. For example, computational fluid dynamics (CFD) can be used to analyze fluid flows using numerical analysis and data structures in order to optimize performance. Finite element analysis, therefore, can be applied to design the reinforcing structure 1204. Examples of suitable materials for the negative region component and the positive region component are discussed further detail below.

The operation of the reaction chamber 102 in the example of FIG. 12 is similar to the operation of conventional thermal batteries. The reinforced solid electrolyte, however, provides a significant advantage over conventional thermal batteries. Since the solid electrolyte is reinforced with a reinforcing structure, the electrolyte is much more resistant to cracking, breaking, deformation, and perforation, as compared to conventional solid electrolytes used in thermal batteries. Although solid electrolytes have been suggested, none of the conventional techniques contemplate using a solid electrolyte with reinforcing structure that at least provides structural support. The reinforcing structure may help to address the limitations of the solid electrolytes and thereby provide advantages to all types of solid electrolytes. As discussed above, for example, ceramic and glass electrolyte materials are brittle and are susceptible to cracking and failure with dangerous consequences without structural reinforcement. Other electrolyte materials with melting points near the operating temperature of the battery are susceptible to deformation and possible perforation when used in a relatively thin form factor without mechanical support provided by a reinforcing structure.

For the examples herein, a reinforced solid electrolyte allows for designs with thinner solid electrolytes while improving performance, reliability, and safety. As the melting point of the salt mixture solid electrolyte approaches the operating temperature rage, the solid electrolyte may experience increased deformation and the possibility of perforation or tearing as the thickness of the solid electrolyte material is reduced. The reinforcing structure minimized deformation, movement, and the chances of perforation of the solid electrolyte. In addition, a reinforcing structure component with sealing properties may be positioned adjacent to electrolyte surfaces not exposed to an electrode material to further reduce deformation and movement while providing a seal.

In at least some examples, therefore, the apparatus includes a reaction chamber having a negative region and a positive region where the negative region contains a negative molten fluid electrode comprising negative molten fluid electrode material being fluid at least within the operating temperature range of the apparatus and the positive region contains a positive molten fluid electrode comprising positive molten fluid electrode material being fluid at least within the operating temperature range of the apparatus. A reinforcing structure at least provides structural support to a solid electrolyte positioned between the negative molten fluid electrode and the positive molten fluid electrode such that the reinforcing structure forms a reinforced solid electrolyte with the solid electrolyte. The reinforced solid electrolyte has a reinforced solid electrolyte strength greater than a solid electrolyte strength of the solid electrolyte without the reinforcing structure. In at least some examples, the reinforcing structure includes a negative region reinforcing structure component and a positive region reinforcing structure. The negative region reinforcing structure component is positioned adjacent to the solid electrolyte in the negative region of the reaction chamber and has an open geometry configured to allow the negative electrode material to flow through the geometry during operation of the apparatus and to contact the solid electrolyte. The positive region reinforcing structure component is positioned adjacent to the solid electrolyte in the positive region of the reaction chamber and has an open geometry configured to allow the positive electrode material to flow through the geometry during operation of the apparatus.

FIG. 13 is a block diagram of a cross-sectional view of an example of a battery 1300 with electrolyte reinforcing current collectors 1302, 1304 where components 1206, 1208 of the reinforcing structure form current collectors 120, 122. The battery 1300, therefore, is an example of the apparatus 100, battery 300, and battery 1200 where the electrolyte reinforcing current collectors perform the functions of the reinforcing structure components 1206, 1208 and the current collectors 120, 122. A negative region electrolyte reinforcing current collector 1302 performs the functions of a reinforcing structure negative region component 1206 and a negative current collector 120. A positive region electrolyte reinforcing current collector 1304 performs the functions of a reinforcing structure negative region component 1208 and a negative current collector 122. The illustration in FIG. 13 depicts the general principles of the example and does not necessarily represent specific shapes, relative sizes, distances, or other structural details of the represented components.

FIG. 14 is a block diagram of a cross-sectional view of an example of a battery 1400 with a reinforcing structure 1402 including a negative region component 1206, a positive region component 1208, and a third component 1404. For the example of FIG. 14, the salt mixture solid electrolyte 108 is a non-brittle solid electrolyte that has a softness greater than ceramic and glass within the operating temperature range of the battery 1400. Also in the example, the negative region component 1206 forms a negative current collector 120 and the positive region component 1208 forms a positive current collector 122. The example of FIG. 14, therefore, includes electrolyte reinforcing current collectors 1302, 1304. The negative electrode material 114 includes fluid lithium (Li) and the positive electrode material 116 includes fluid sulfur (S) during operation of the battery 1400 in the example. The salt mixture solid electrolyte 108 comprises a salt mixture having at least one salt that comprises lithium. The battery 1400, therefore, includes a fluid lithium (LiI) negative electrode and a fluid sulfur (S) positive electrode separated by a reinforced lithium salt mixture solid electrolyte. Accordingly, the battery 1400 can be referred to as a lithium-sulfur (LiS) battery and is an example of the apparatus 100, battery 300, and battery 1300 where the fluid negative electrode comprises lithium, the fluid positive electrode comprises sulfur and the solid electrolyte comprises a solid lithium salt mixture electrolyte. The techniques discussed with reference to FIG. 14, however, may be used with different materials and configurations where the techniques may be more advantageous in situations where the salt mixture solid electrolyte 108 is relatively soft and non-brittle. The illustration in FIG. 14 depicts the general principles of the example and does not necessarily represent specific shapes, relative sizes, distances, or other structural details of the represented components. In some circumstances, the structures of two or more blocks may be implemented in a single component or structure. In addition, functions described as performed in a single block of FIG. 14 may be implemented in separate structures.

The negative region reinforcing structure component 1206 and the positive region reinforcing structure component 1208 operate in accordance with the description with reference to FIG. 12 and FIG. 13. The third component 1404 provides additional structural support to the solid electrolyte 108. In some situations, the third component 1404 may also seal at least one edge of the salt mixture solid electrolyte 108 in addition to providing support. Since the solid electrolyte is operated near its melting point, the salt mixture solid electrolyte 108 is relatively flexible and possibly susceptible to deformation due to forces experienced during operation of the battery 1400. The third component 1404, the negative region reinforcing structure component 1206, and the positive region reinforcing structure component 1208 collectively secure the salt mixture solid electrolyte 108 to minimize movement, deformation, and damage to the solid electrolyte 108. For the example, the third component 1404 is electrically nonconductive, sufficiently impermeable, chemically compatible with the solid electrolyte, and sufficiently strong to support the solid electrolyte. The composition of the third component may be further selected based upon its ability to form a seal and its compatibility with the molten electrode materials as well as cost. In situations where the third component does not provide a sealing function, additional battery components may be required to insulate the solid electrolyte from external elements. An additional hull, for example, may be needed to seal the solid electrolyte from the environment. An example of suitable material of the third component 1404 of the reinforcing structure 1402 that forms a seal comprises mica or boron nitride.

The third component 1404 is positioned between a negative hull portion 1406 and a positive hull portion 1408. The hull portions 1406, 1408 are metal and are chemically stable with the materials of the electrodes 104, 106, solid electrolyte 108, and reinforcing structure components 1206, 1208, 1404. In situations where the metal material of the hull portions 1406, 1408 is not chemically stable with the electrodes, a chemically stable coating can be applied to the hull portions 1406, 1408. Since the hull portions 1406, 1408 are electrically conductive, the portions 1406, 1408 are not in contact with each other.

In addition to considerations such as melting point, softness, and cost, selection of an electrolyte material for the LiS thermal battery includes evaluating ionic transfer properties and the chemical stability of the material with lithium, sulfur and the Li₂Sₘ species. Experiments performed by the inventor have revealed that lithium iodide is chemically stable with lithium, sulfur and the Li₂Sₘ species at elevated temperatures.

The operation of the LiS battery 1400 is in accordance with the operation described with reference to the apparatus 100 and batteries 300, 1300 of FIG. 1, FIG. 3, FIG. 12 and FIG. 13. The heating system 118 (not shown in FIG. 14) maintains the reaction chamber 102 at the appropriate temperature to facilitate the desired reaction between the sulfur and lithium through the reinforced lithium salt mixture solid electrolyte 108. For the example of FIG. 14, the temperature of the negative electrode region 110 and the positive electrode region 112 is maintained at a temperature around 400 degrees Celsius (° C.). The operating temperature may be based on several factors including the characteristics of the materials of the electrodes and solid electrolyte. For the example of FIG. 14, some of the characteristics that can be considered include the melting point of the lithium salt mixture solid electrolyte, the boiling point of sulfur, 444.6° C., and the eutectic melting point of lithium polysulfide products (LiₙSₘ), 365° C. A temperature range that is above the eutectic melting point of lithium polysulfide products but below the established melting point of the lithium salt mixture solid electrolyte provides the temperature range of 365° C. to the established melting point. For example, if the desired melting point of the lithium salt mixture is established or selected to be 500° C., a suitable temperature range is 365° C. to 500° C., which can be used in some circumstances. Maintaining the temperature below the boiling point of sulfur may be useful and provide a range of 365° C. to 444° C. that can be used in other circumstances. A suitable temperature range, however, includes temperatures between 375° C. and 425° C. The wider temperature range of 115.21° C. to 500° C. can also be used in still other situations. For the examples herein, the temperatures of the negative electrode region 110 and the positive electrode region 112 are maintained at approximately the same temperature. Among other advantages, such a scheme avoids a temperature gradient across the reinforced lithium salt mixture solid electrolyte. In some situations, however, the temperatures may be different between the electrode regions. Other temperature ranges and schemes can be used as long as the electrode materials are fluid and the electrolyte is solid. As a result, the temperature of the positive electrode region 112 should be above the melting point of sulfur, 115.21° C., and the negative electrode region 114 should be above the melting point of lithium, 180.5° C.

During operation of the battery 1400, the reaction may result in other compounds or products being formed. For example, in addition to the positive electrode region containing sulfur, the region may also contain di-lithium polysulfide species (Li₂Sₙ) where n is two or higher and di-lithium sulfide (Li₂S). Typically, the reaction through the electrolyte will result is several different chemical species such as Li₂Sₘ where m is an integer equal to one or more. Any number of chemical species may result and may include, for example Li₂S, Li₂S₂, Li₂S₄, and Li₂S₆ products as well as others in some circumstances. The production of these products and their impact on electrode material flow through the reinforcing structure may be considered in selecting the materials and geometry of at least some of the reinforcing structure components. With some design techniques, computational fluid dynamics (CFD), finite element analysis and/or other modeling techniques that take into account the reactive products may be used to analyze fluid flows using numerical analysis and data structures.

In some situations, additional materials may be added to the positive electrode material and/or to the negative electrode material. For example, phosphorus can be included in the positive electrode material resulting in a fluid phosphorus-sulfur positive electrode. According, another example of the fluid electrode battery apparatus 1400 is a lithium phosphorus-sulfur (LiPS) battery. In one example, therefore, the positive electrode material comprises sulfur and, in another example, the positive electrode material comprises sulfur and phosphorous. Examples of suitable temperature ranges for the reservoirs and reaction chamber for a LiPS battery include the ranges discussed above with reference to the LiS battery 1400 of FIG. 14.

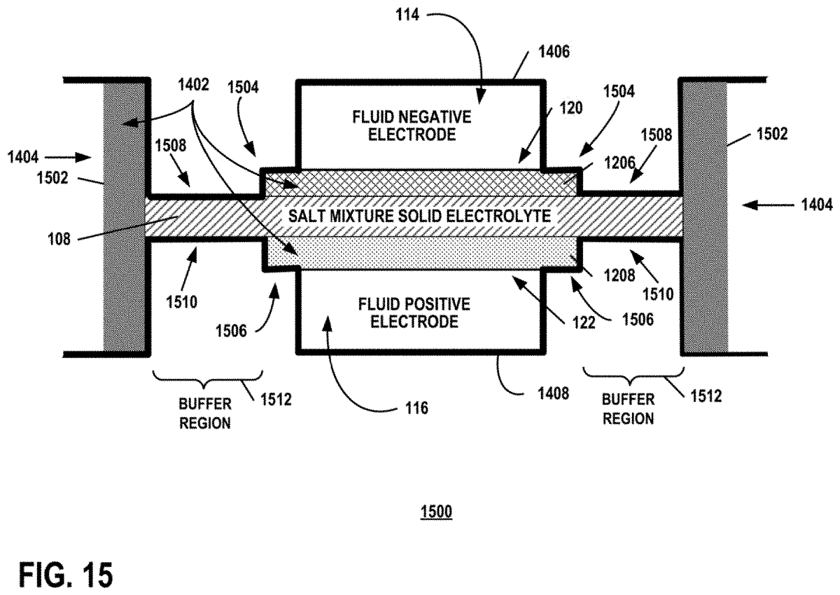

FIG. 15 is a block diagram of a cross-sectional view of an example of a battery 1500 where the third component 1404 is a sealing component 1502. The reinforcing structure 1402 includes a negative region component 1206, a positive region component 1208, and a third component 1404 that also provides sealing functionality as a sealing component 1502. The battery 1500 is an example of the battery 1400 described above with reference to FIG. 14 and has an operation in accordance with the operation of the battery 1400.

The negative hull portion 1406 and the positive hull portion 1408 include securing features 1504, 1506 that secure the negative region component 1206 and the positive region component 1208 within the structure of the battery 1500. For the example, a negative region component securing feature 1504 includes a lateral hull portion that is adjacent and parallel to the negative region component 1206 such that the component 1206 is securely positioned against the salt mixture solid electrolyte 108. Similarly, a positive region component securing feature 1506 includes a lateral hull portion that is adjacent and parallel to the positive region component 1208 such that the component 1208 is securely positioned against the solid electrolyte 108. The securing features 1504, 1506 may be implemented in other ways. For example, tabs extending from the hull wall may be used instead of a bended hull shape.

The negative hull portion 1406 and the positive hull portion 1408 also include extension sealing features 1508, 1510 that provide a buffer region 1512 between the electrode hull portions 1406, 1408 and the sealing component 1502. The salt mixture solid electrolyte 108 extends beyond the edges of the negative region 110 and the positive region 112 between the negative region extension sealing feature 1508 and the positive region extension feature 1510. The length of the formed buffer region 1512 is such that the interface between the sealing component 1502 and the salt mixture solid electrolyte 108 is sufficiently distant from the edge of the electrodes 104, 106 to avoid leakage of the electrode materials around the solid electrolyte.

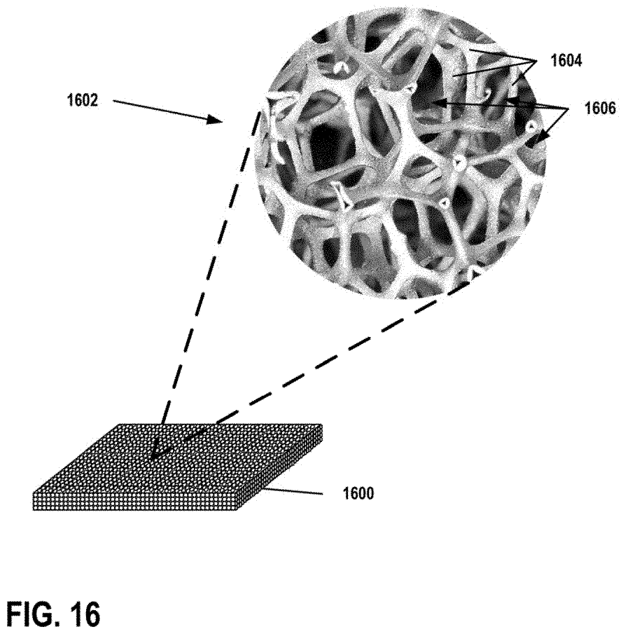

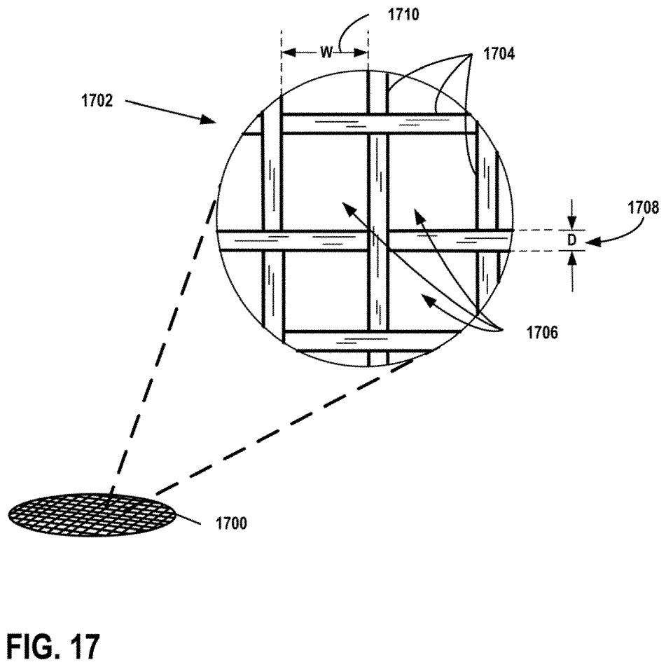

An example of suitable material of the sealing component 1502 includes mica and boron nitride. Accordingly, the different components of the reinforcing structure 1402 may be formed from different materials. Some examples of reinforcing structure materials for the negative region component 1206 and the positive region component 1208 include wire meshes and open cell foams. An example of an open cell foam material is discussed with reference to FIG. 16 and an example of a wire mesh is discussed with reference to FIG. 17. of different materials, such as metal foams, ceramic foams, glass foams, woven wire meshes, and fiberglass meshes. Other types of reinforcing structure materials can be used in some situations. Depending on the particular battery materials, a coating may be required to protect the reinforcement structure from chemical attack. Where the reinforcing structure material is electrically conductive, a dielectric material may be deposited onto the structure to transform the overall structure from electrically conductive to non-electrically conductive. Where the reinforcing structure component is used as a current collector, however, dielectric coatings are avoided where the reinforcing structure is metal although electrically conductive coatings may be used for protection against unwanted chemical interaction with the electrode materials. In some situations, an electrically conductive coating may be used on an electrically nonconductive reinforcing structure material.

Therefore, various materials, structures, and coatings may be used to form the reinforcing structure components. Some general characteristics of the negative region component 1206 and positive region component 1208 that may provide advantages include having an open cell structure, providing current collector functions, being electrically conductive, including iron for mechanical strength and have a coating. Examples of coatings that can be applied to the material including iron of a negative region component in a battery with molten fluid lithium include molybdenum, vanadium, niobium, tungsten and titanium. Examples of coatings that can be applied to the material including iron of a positive region component in a battery with molten fluid molten sulfur include molybdenum, W doped rutile titanium dioxide, and other doped rutile titanium dioxide materials.

FIG. 16 is an illustration of an example of a block of open cell foam 1600 suitable for use as a reinforcing structure component 1206, 1208 to reinforce the salt mixture solid electrolyte 108 within a thermal battery. The open cell foam structure may comprise a metal, a ceramic, carbon, a metal alloy, layer of a metal, multiple layers of differing metals or alloys, a layer of a ceramic, metal oxides that have been doped to make them electrically conductive. The reinforcing structure material is selected and processed to form a mechanically sound reinforcing structure that can withstand the operating temperatures of the battery and that is chemically stable and compatible with components of the battery that contact the reinforcing structure. Material is selected and processed to be electrically conductive or electrically non-conductive based on the requirements of battery design. A magnified view of the foam structure 1602 in the example reveals a structure with structure components 1604 separated by pores (open spaces) 1606. The foam for the example has an open cell structure where the pores 1606 between the components 1604 of the foam 1600 are interconnected. Examples of suitable open cell foam materials include carbon steel, cast iron, low alloy steels, stainless steels, such as SS316, SS304, and SS410, Titanium, Ti alloys, Ni alloys, Tungsten, W alloys, niobium, vanadium, molybdenum, ceramics (e.g. silicon carbide (SiC), B4C, magnesia (MgO), calcium oxide (CaO), boron nitride (BN), zirconia, cordierite, alumino-silicates, Macor®, Mullite, and aluminum nitride (AlN)), graphite, carbon, Steatite L-5, quartz, sapphire, silicon, silica glass, soda glass, borosilicate, brick, stone, and concrete.

FIG. 17 is an illustration of an example of a section of wire mesh 1700 suitable for use as a reinforcing structure component 1206, 1208 to reinforce the salt mixture solid electrolyte 108 within a thermal battery. The relative dimensions in FIG. 17 are not necessarily to scale. The wire mesh structure 1700 may be formed with metal wires that may comprise a metals and metal alloys. The reinforcing structure wire mesh structure is selected and processed to form a mechanically sound reinforcing structure that can withstand the operating temperatures of the battery and that is chemically stable and compatible with components of the battery that contact the reinforcing structure. The material is selected and processed to be electrically conductive or electrically non-conductive based on the requirements of the battery design. A magnified view of the wire mesh structure 1702 in the example reveals a structure with several weaved wires 1704 that are separated sufficiently to provide openings 1706. The wires have diameter, D 1708 and the openings have width, W 1710. The wire mesh 1700 can also be characterized based on the number of wires per inch and the percentage of open area. Examples of suitable wire mesh materials include carbon steel, cast iron, low alloy steels, stainless steels, such as SS316, SS304, and SS410, Titanium, Ti alloys, Ni alloys, Tungsten, W alloys, niobium, vanadium, molybdenum, ceramics (e.g. silicon carbide (SiC), B4C, magnesia (MgO), calcium oxide (CaO), boron nitride (BN), zirconia, cordierite, alumino-silicates, Macor®, Mullite, and aluminum nitride (AlN)), graphite, carbon, Steatite L-5, quartz, sapphire, silicon, silica glass, soda glass, and borosilicate. The Examples of suitable Molybdenum wire mesh structures include Molybdenum wires meshes shown in Table 1 below.

TABLE 1

| | Wires/ | Wire Diameter | Width Opening | % Open |
|---|---|---|---|---|
| Example | Inch | (Inches) | (Inches) | Area |
| 1 | 100 × 100 | 0.0010 | 0.0090 | 81.0 |
| 2 | 50 × 50 | 0.0020 | 0.0180 | 81.0 |
| 3 | 35 × 35 | 0.0020 | 0.0266 | 86.5 |

It should be understood that, depending on the example, certain acts or events of any of the methods described herein can be performed in a different sequence, may be added, merged, or left out altogether (e.g., not all described acts or events are necessary for the practice of the method). Moreover, in certain examples, acts or events may be performed concurrently, rather than sequentially or even reversed. In addition, while certain aspects of this disclosure are described as being performed by a single module or component for purposes of clarity, it should be understood that the functions described in this disclosure may be performed by any suitable combination of components.

Clearly, other embodiments and modifications of this invention will occur readily to those of ordinary skill in the art in view of these teachings. The above description is illustrative and not restrictive. This invention is to be limited only by the following claims, which include all such embodiments and modifications when viewed in conjunction with the above specification and accompanying drawings. The scope of the invention should, therefore, be determined not with reference to the above description, but instead should be determined with reference to the appended claims along with their full scope of equivalents.

What is claimed is:

1. An apparatus comprising:
a negative fluid electrode comprising a negative electrode material, the negative fluid electrode being fluid at least within an operating temperature range of the apparatus;
a positive fluid electrode being fluid at least within the operating temperature range of the apparatus; and
a solid electrolyte positioned between the negative fluid electrode and the positive fluid electrode, the solid electrolyte comprising a mixture of a plurality of salts with at least one of the salts having cations of the negative electrode material, each of the plurality of salts having a proportion in the mixture where the proportions determine an absolute melting point of the mixture such that the solid electrolyte is in a solid state at least within the operating temperature range of the apparatus.

2. The apparatus of claim 1, wherein an upper temperature of the operating temperature range is greater than 70 percent of the absolute melting point of the solid electrolyte.

3. The apparatus of claim 2, wherein an upper temperature of the operating temperature range is greater than 85 percent of the absolute melting point of the solid electrolyte.

4. The apparatus of claim 3, wherein an upper temperature of the operating temperature range is greater than 90 percent of the absolute melting point of the solid electrolyte.

5. The apparatus of claim 4, wherein an upper temperature of the operating temperature range is greater than 99 percent of the absolute melting point of the solid electrolyte.

6. The apparatus of claim 1, wherein an upper temperature of the operating temperature range is below a lowest boiling point of a positive electrode boiling point of the positive fluid electrode and a negative electrode boiling point of the fluid negative electrode.

7. The apparatus of claim 6, wherein the upper temperature of the operating temperature range is below 99 percent of the lowest absolute boiling point of a positive electrode absolute boiling point of the positive fluid electrode and a negative electrode absolute boiling point of the fluid negative electrode.

8. The apparatus of claim 1, wherein the at least one of the salts having cations of the negative electrode material comprises lithium (Li).

9. The apparatus of claim 1, wherein the solid electrolyte has a lattice with defects.

10. An apparatus comprising:
a negative fluid electrode comprising lithium, at least a portion of the negative fluid electrode being fluid at least within an operating temperature of the apparatus;
a positive fluid electrode comprising sulfur, at least a portion of the positive fluid electrode being fluid at least within the operating temperature of the apparatus; and
a solid electrolyte positioned between the negative fluid electrode and the positive fluid electrode, the solid electrolyte comprising a mixture of a plurality of salts with at least one of the salts having lithium cations, each of the plurality of salts having a proportion in the mixture where the proportions determine an absolute melting point of the mixture such that the solid electrolyte is in a solid state at least within the operating temperature range of the apparatus, the operating temperature range of the apparatus contained within a range of 365° C. to 444° C.

11. The apparatus of claim 10, wherein the operating temperature range of the apparatus is contained with a range of 375° C. to 430° C.

12. The apparatus of claim 11, wherein the operating temperature range of the apparatus is contained with a range of 390° C. to 425° C.

13. The apparatus of claim 10, wherein the solid electrolyte has a lattice with defects.

14. The apparatus of claim 10, further comprising:
a heating system arranged and configured to heat the fluid negative electrode, the fluid positive electrode and the solid electrolyte to an operating temperature of the apparatus.

15. An apparatus comprising:
a negative fluid electrode comprising a negative electrode material, the negative fluid electrode being fluid at least within an operating temperature range of the apparatus;
a positive fluid electrode being fluid at least within the operating temperature range of the apparatus; and
a solid electrolyte positioned between the negative fluid electrode and the positive fluid electrode, the solid electrolyte comprising a mixture of a plurality of salts with at least one of the salts having cations of the negative electrode material, each of the plurality of salts having a proportion in the mixture where the proportions determine an absolute melting point of the mixture such that the solid electrolyte is in a solid state at least within the operating temperature range of the apparatus, the solid electrolyte having a lattice comprising the cations, a plurality of anions and a plurality of defects.

16. The apparatus of claim 15, wherein the plurality of defects comprises a plurality of grain boundary defects associated with introduction of a plurality of nanoparticles to the at least one of the salts having cations of the negative electrode material.

17. The apparatus of claim 16, the plurality of grain boundary defects comprising at least one of:
a plurality of nanoparticle grain boundary defects resulting at grain boundaries of the plurality of nanoparticles; and
a plurality of pinned grain boundary defects formed prior to the introduction of the plurality of nanoparticles and maintained in the lattice at least partially as a result of the introduction of the plurality of nanoparticles.

18. The apparatus of claim 17, wherein the nanoparticles comprise magnesium oxide (MgO).

19. The apparatus of claim 15, wherein the plurality of defects comprises a plurality of aliovalent substitution defects.

20. An apparatus comprising:
a negative molten fluid electrode within a negative region of a reaction chamber, the negative molten fluid electrode comprising negative electrode material being fluid at least within the operating temperature range of the apparatus;
a positive molten fluid electrode within a positive region of the reaction chamber, the positive molten fluid electrode comprising positive electrode material being fluid at least within the operating temperature range of the apparatus;
a solid electrolyte positioned between the negative molten fluid electrode and the positive molten fluid electrode, the solid electrolyte comprising a mixture of a plurality of salts with at least one of the salts having cations of the negative electrode material, each of the plurality of salts having a proportion in the mixture where the proportions determine an absolute melting point of the mixture such that the solid electrolyte is in a solid state at least within the operating temperature range of the apparatus;
a negative region reinforcing structure component positioned adjacent to the solid electrolyte in the negative region of the reaction chamber and having an open geometry configured to allow the negative electrode material to flow through the geometry during operation of the apparatus and to contact the solid electrolyte; and
a positive region reinforcing structure component positioned adjacent to the solid electrolyte in the positive region of the reaction chamber and having an open geometry configured to allow the positive electrode material to flow through the geometry during operation of the apparatus.
